(19) United States
(12) Patent Application Publication
(10) Pub. No.: US 2026/0310179 A1
(43) Pub. Date: Oct. 8, 2026

(54) INPUT DEVICE, CONTROL METHOD, ARTICLE MANUFACTURING METHOD, AND RECORDING MEDIUM

(71) Applicant: CANON KABUSHIKI KAISHA, Tokyo (JP)

(72) Inventor: KAZUMORI INAGAKI, Kanagawa (JP)

(21) Appl. No.: 19/574,797

(22) Filed: Mar. 23, 2026

(30) Foreign Application Priority Data
Apr. 7, 2025 (JP) 2025-063331

(51) Int. Cl. G05B 19/418

(52) U.S. Cl. CPC G05B 19/4183; G05B 19/41845

(57) ABSTRACT

An input device includes an information processing unit, a display unit, and an input unit. The input unit is configured to receive an input operation for controlling equipment. The information processing unit is configured to acquire first information regarding the input operation on the input unit and second information regarding a state change of the equipment caused by work performed on the equipment, and display, on the display unit, an image in which information regarding the input operation is associated with information regarding the state change of the equipment caused by the work based on the first information and the second information.

### BACKGROUND

### Field of the Technology

The present disclosure relates to an input device used when a user operates equipment.

### Description of the Related Art

For example, a facility, a device, equipment, and the like (hereinafter, collectively referred to as equipment) installed at a production site are generally configured to be operable by a user using an input device such as an operation panel. For convenience when the user operates the equipment, the input device such as the operation panel may include a display unit that displays information regarding the equipment and a button for operating the equipment.

JP 2023-22699 A describes that a control system that controls a control target includes an operation display system. The operation display system described in JP 2023-22699 A records a history of a user operation and an event, extracts a user operation pattern from the record, and generates and displays an operation object included in the extracted operation pattern.

In a case where an error occurs in the equipment or the equipment is inspected, an operator is required to appropriately perform an input operation on the operation panel, appropriately perform work around the equipment, and quickly complete the work. In such a situation, if it takes time for the operator to determine screen transition of the operation panel or the order of button operations, it takes a long time to complete the work.

In order to solve such a problem, JP 2023-22699 A discloses a method of collectively generating, on one screen, operation buttons included in a plurality of screens by using operation history information. According to the method, the number of button operations and a determination time when operating the equipment are reduced, and it is thus expected that a work time can be reduced to some extent.

In the operation display system described in JP 2023-22699 A, for example, an operation pattern executed by the user at a high frequency can be extracted, and an operation object used in the operation pattern can be generated and displayed. Therefore, an operation object unnecessary for controlling the control target with the operation pattern is not generated, the redundancy of a display image is reduced, and user operability can be improved.

On the other hand, for example, in a case where an error occurs in the equipment or in a case where the equipment is inspected or maintained, the user needs to perform not only the input operation of controlling an operation of the equipment using the input device such as the operation panel but also various types of work on the equipment. Examples of the various types of work can include physical work such as work of opening and closing a safety door of the equipment, work of removing a workpiece in process from the equipment, and work of changing a posture of the equipment without using the operation panel. The user needs to appropriately determine and perform a work content to be performed at that time according to a status of the equipment and a progress status of the work.

As described above, the user needs to appropriately perform the input operation of controlling the operation of the equipment by using the input device and perform various types of work on the equipment, but the operation display system described in JP 2023-22699 A cannot appropriately support the user.

### SUMMARY

One of the problems to be solved by the embodiments disclosed in the present specification and the drawings is that a technology for supporting a user who performs an input operation of controlling an operation of equipment by using an input device and performs work on the equipment was not provided. However, the problems to be solved by the embodiments disclosed in the present specification and the drawings are not limited to the above problem. A problem corresponding to each effect achieved by each configuration described in the embodiments described below can also be regarded as another problem.

According to a first aspect of the present disclosure, an input device includes an information processing unit, a display unit, and an input unit. The input unit is configured to receive an input operation for controlling equipment. The information processing unit is configured to acquire first information regarding the input operation on the input unit and second information regarding a state change of the equipment caused by work performed on the equipment, and display, on the display unit, an image in which information regarding the input operation is associated with information regarding the state change of the equipment caused by the work based on the first information and the second information.

According to a second aspect of the present disclosure, an input device includes an information processing unit, a display unit, and an input unit and in which the input unit receives an input operation for controlling equipment. A control method for controlling the input device include acquiring, by the information processing unit, first information regarding the input operation on the input unit and second information regarding a state change of the equipment caused by work performed on the equipment, and displaying, by the information processing unit, an image in which information regarding the input operation is associated with information regarding the state change of the equipment caused by the work based on the first information and the second information on the display unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an overall configuration of a production system.

FIG. 2 is a schematic diagram illustrating a functional relationship of each component in the production system to which an input device according to an embodiment is applied.

FIG. 3A is a view illustrating an example of a display screen displayed on a display unit of an operation panel when operating a production device.

FIG. 3B is a view illustrating an example of a display screen displayed on the display unit of the operation panel when operating a transfer robot.

FIG. 3C is a view illustrating an example of a display screen displayed on the display unit of the operation panel when operating an assembly robot.

FIG. 4 is a flowchart illustrating a handling procedure when an error occurs.

FIG. 5A is a diagram illustrating operation information data obtained by recording operation information input to the operation panel in time series by an operation history acquisition unit in a table format.

FIG. 5B is a diagram illustrating state change information data obtained by recording state information of equipment acquired by the operation panel from a programmable logic controller (PLC) in time series by a state change history acquisition unit in a table format.

FIG. 6 is a data list illustrating an example of data in which the operation information input to the operation panel and the state change information of the equipment are associated with each other in a table format.

FIG. 7 is a flowchart illustrating an example of a procedure of creating a work handling screen using the operation information and the state change information.

FIG. 8A is a view illustrating a work handling screen created using only the operation information.

FIG. 8B is a view illustrating a work handling screen created using both the operation information and the state change information.

FIG. 9 is a view illustrating a state information screen in which a state information dictionary 1 is selected.

FIG. 10 is a view illustrating a state information screen in which a state information dictionary 2 is selected.

FIG. 11 is a view illustrating an example of a screen for editing a handling history on a handling history screen.

FIG. 12 is a view illustrating an example of a screen for editing state monitoring data on the handling history screen.

FIG. 13 is a view illustrating an example of a screen for editing a setting on the handling history screen.

FIG. 14 is a flowchart illustrating a main flow of a procedure of recording the handling history.

FIG. 15 is a flowchart of another task (acquisition of the state information) executed in the flow of FIG. 14.

FIG. 16 is a view illustrating an example of a handling recording screen displayed on an operation screen.

FIG. 17 is a view illustrating an example in which the operation screen and a handling reproduction screen are simultaneously displayed.

FIG. 18 is a view illustrating an example in which the handling reproduction screen and a screen illustrating the equipment which is a control target (work target) are simultaneously displayed.

FIG. 19 is a schematic block diagram illustrating an example of a configuration in which the input device (operation panel) communicates with the production device which is the control target by using a wireless communication device.

FIG. 20 is a schematic block diagram illustrating functions of the operation panel of FIG. 19.

FIG. 21 is a view illustrating an example in which the handling reproduction screen and the screen illustrating the equipment, which is the control target (work target), and an operator are simultaneously displayed.

FIG. 22A illustrates an example in which a button on a screen for operating the transfer robot illustrated in FIG. 3B is implemented in another display form.

FIG. 22B illustrates an example in which each button on the screen for operating the transfer robot illustrated in FIG. 3B is implemented by another display form.

FIG. 23 is a diagram illustrating an example in which a column is added to the data list of FIG. 6.

FIG. 24 is a view illustrating an example of a screen displaying input information (for example, releasing of a workpiece) and information regarding the work target related to the input information (for example, opening and closing of a safety door, and the presence or absence of the workpiece).

### DESCRIPTION OF THE EMBODIMENTS

An input device and the like according to an embodiment of the present disclosure will be described with reference to the drawings. The embodiments described below are merely examples, and for example, detailed configurations can be appropriately changed and implemented by those skilled in the art without departing from the gist of the present disclosure.

In the drawings referred to in the following embodiments and description, elements denoted by the same reference numerals have similar functions unless otherwise specified. In the drawings, in a case where a plurality of the same elements are arranged, reference numeral and a description thereof may be omitted.

In addition, the drawings may be schematic for convenience of illustration and description, and thus, the shape, size, arrangement, and the like of elements in the drawings may not strictly match those of actual ones.

In the description of the present specification, a target to be controlled using the input device may be referred to as “equipment”, but a type and a scale of the control target are not particularly limited. That is, the “equipment” referred to in the present specification only needs to be a target object whose operation is controlled using the input device, and widely includes, for example, those generally called a facility, a device, a system, a machine, and the like.

In addition, in the description of the present specification, the control of the operation of the equipment by a user (operator) using the input device may be referred to as “operation”, and an action performed by the user on the input device at that time may be referred to as “input operation”. An action performed by the user (operator) on the equipment may be referred to as “work” regardless of whether or not the user uses the input device. That is, an action performed on the equipment by the input operation and an action performed on the equipment regardless of the input operation may be referred to as “work”.

Hereinafter, an example in which the input device according to the embodiment is used as an operation panel in a production system that manufactures an article will be described. First, an overall configuration of the production system will be described, and then a configuration and an operation of the operation panel which is the input device including a display unit will be described. Furthermore, a characteristic image displayed on the display unit of the operation panel in order to enable an operator to quickly and safely operate the equipment and perform work on the equipment will be described together with an image generation procedure. Further, a plurality of embodiments will be described in detail.

### Production System

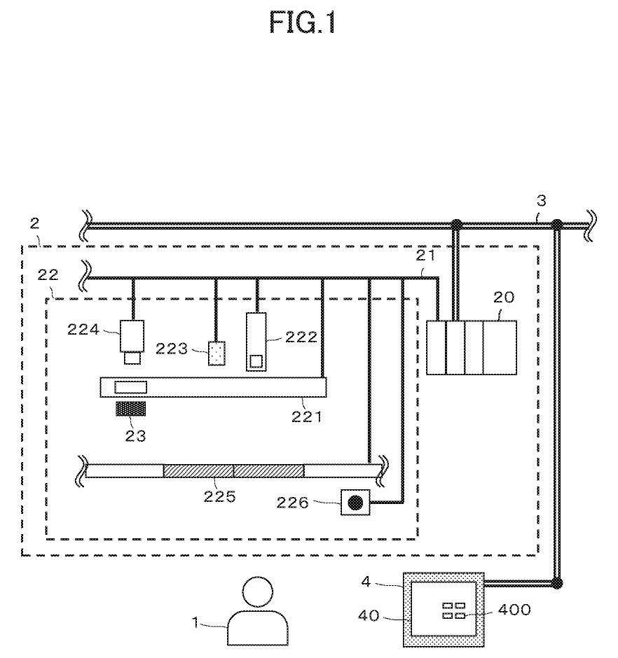

FIG. 1 is a schematic diagram illustrating the overall configuration of the production system, and the production system includes an operator 1, a production device 2, a communication-system network 3, and an operation panel 4 serving as the input device. The production device 2 includes a programmable logic controller (PLC) 20, a control system network 21, and equipment 22, and a workpiece 23, which is a part or a work-in-process of a product to be produced, can be disposed inside the equipment 22.

The PLC 20 included in the production device 2 is communicably connected to the operation panel 4 serving as the input device via the wireless or wired communication-system network 3. The PLC 20 is communicably connected to a component of the equipment 22 via the control system network 21.

The equipment 22 is equipment capable of performing at least a part of an article manufacturing process. The equipment 22 illustrated in FIG. 1 includes a transfer robot 221, an assembly robot 222, a sensor 223, a camera 224, a safety door 225, and an external button 226, but the equipment used in the embodiment is not limited to this example and can be configured in various modes. The transfer robot 221 is a robot for transferring the workpiece 23, and the assembly robot 222 is a robot for assembling a plurality of workpieces. The sensor 223 is a sensor that detects the presence or absence of the workpiece 23 and a location of the workpiece 23, and the camera 224 is a camera that images an assembly status of the workpieces 23 and the like. The safety door 225 is a door that can be opened and closed according to a command of the PLC 20, and prevents the operator from entering an operation range when the transfer robot 221 or the assembly robot 222 is operating. The safety door 225 can be manually opened and closed by the operator, and transmits information regarding an opened and closed state to the PLC 20. In a case where the safety door 225 is manually opened during manufacturing of the article, the PLC 20 can transmit a command to stop, for example, the transfer robot 221 or the assembly robot 222. The external button 226 is, for example, a button used in a case where the operator urgently stops the operation of the equipment 22, and when the external button 226 is pressed, the external button 226 transmits the information to the PLC 20.

The PLC 20 receives a command for controlling the equipment 22 from the operation panel 4, and controls an operation of the component (for example, the transfer robot 221, the assembly robot 222, or the safety door 225) of the equipment 22 based on the command. The PLC 20 receives information regarding a state of the equipment 22 from the component (for example, sensor 223, camera 224, safety door 225, or external button 226) of the equipment 22, and transmits the information to the operation panel 4.

The operation panel 4 includes a display unit 40 serving as a display screen capable of receiving a touch input, and is connected to the PLC 20 via the communication-system network 3. The operation panel 4 includes an input unit that can detect the touch input (input operation) on the display screen by the operator 1, and for example, the operation panel 4 can transmit, to the PLC 20, an operation command for the production device 2, the operation command being input by the operator 1. The PLC 20 that has received the operation command from the operation panel 4 drives the equipment 22 in the production device 2 according to the operation command. The operation panel 4 may be connected to a PLC of another production device, a computer or a database in the system, an external network, an external computer, or the like via the communication-system network 3.

The operation panel 4 includes a computer (control unit) (not illustrated) that controls the operation panel 4, and the computer includes a central processing unit (CPU), a read only memory (ROM), a random access memory (RAM), an input/output (I/O) port, and the like therein. The ROM stores an operation program of the operation panel 4. A program for performing various types of processing according to a control method for the operation panel 4 serving as the input device may be stored in the ROM similarly to other operation programs, and may be loaded from the outside into the RAM via a network. Alternatively, the program may be loaded into the RAM via a computer-readable recording medium in which the program is recorded. A processing program of the CPU for implementing the control method can be supplied to each of the above-described storage units via a storage unit such as various magnetic disks, optical disks, and flash memories and a drive device therefor, and can update contents thereof. A program that enables processing in the CPU for implementing the control method for the operation panel 4 is included in the embodiment of the present disclosure. In addition, various storage units or storage devices storing the program are included in the embodiment of the present disclosure as computer-readable recording media.

The display unit 40 can display information regarding the production device 2 and can display an image (for example, an input button) for receiving the input operation from the operator 1. For example, the display unit 40 can display information regarding the state of the equipment 22, which is transmitted from the PLC 20, and an operating screen for operating the equipment 22. Specifically, the display unit 40 can display a plurality of buttons 400 such as a button for switching information related to the production device 2 to be displayed and a button for operating the production device 2. The display unit 40 is not necessarily a display device having a touch input function. A physical switch may be provided as an input unit outside the display screen instead of some or all of the buttons 400.

The operator 1 at a production site can safely remotely operate the production device 2 by performing the input operation on the operation panel 4 from the outside of the safety door 25. A plurality of operation panels 4 may be connected to the production device 2, or a plurality of production devices 2 may be connected to the operation panel 4.

### Functional Relationship of Each Component

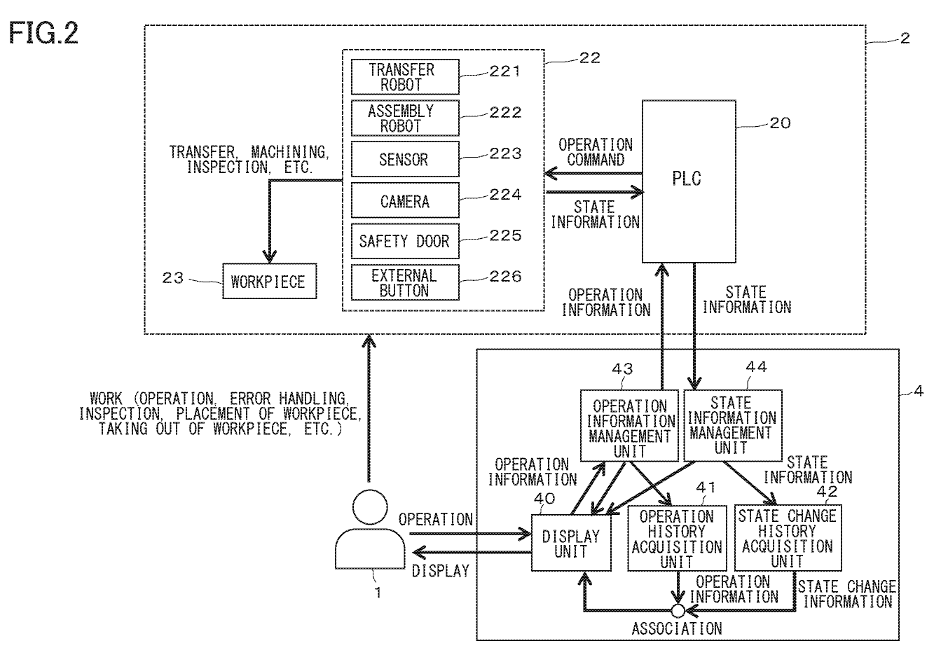

FIG. 2 is a schematic diagram illustrating a function and a functional relationship of each component in the production system to which the input device according to the embodiment is applied. The operator 1 presses a button displayed on the display unit 40 of the operation panel 4 which is the input device, and performs the input operation such as inputting data using the operation panel 4, whereby the operator 1 can command the production device 2 to operate or stop. From the viewpoint of processing on the workpiece 23 in manufacturing the article, the operation commands such as a workpiece transfer command, a workpiece machining command, a workpiece assembling command, and a workpiece inspection command can be included. The operation command includes specific commands such as a command for moving the transfer robot 221 and the assembly robot 222, a command for imaging using the camera 224, and a command for locking and unlocking the safety door 225.

The operation panel 4 includes, as information processing units, for example, an operation history acquisition unit 41, a state change history acquisition unit 42, an operation information management unit 43, a state information management unit 44, and the like, but such functional elements are functionally conceptual and do not necessarily have to be physically implemented as illustrated. For example, a specific form of distribution or integration of the respective functional blocks is not limited to the illustrated example, and all or some of the functional blocks can be functionally or physically distributed and integrated in arbitrary units according to a use situation or the like. Each functional block can be configured using hardware or software.

The operation information management unit 43 transmits information (operation information) input to the operation panel 4 by the operator 1 to the PLC 20. The PLC 20 transmits the operation command to the equipment 22 based on the operation information received from the operation panel 4. The equipment 22 performs an operation based on the operation command transmitted from the PLC 20.

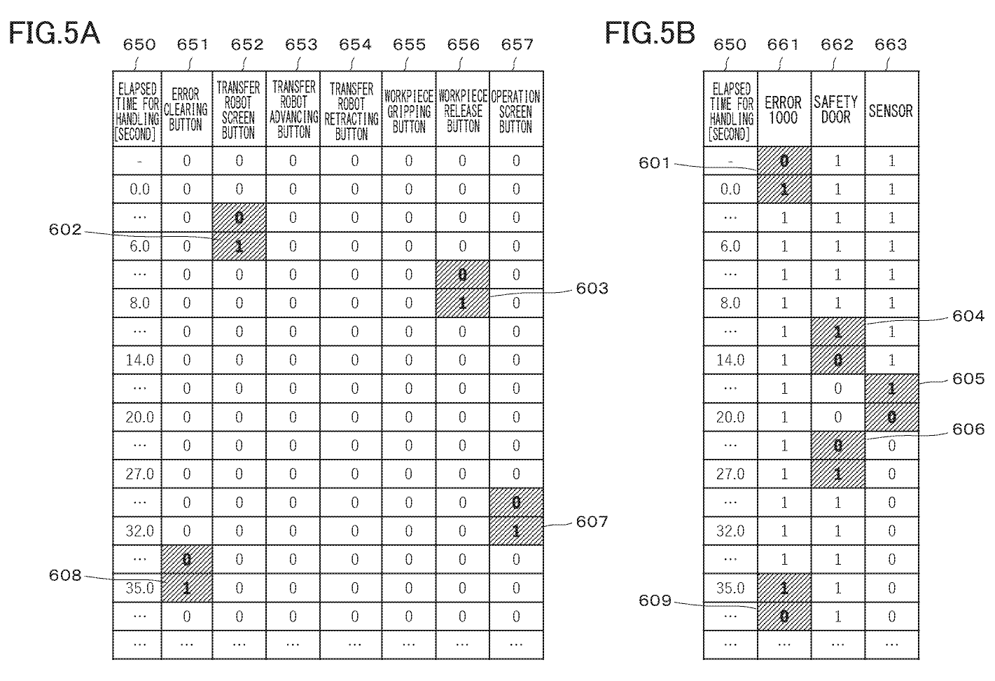

The operation information management unit 43 can cause the display unit 40 to display the information (operation information) input to the operation panel 4 by the operator 1. By viewing the information displayed on the display unit 40, the operator 1 can confirm a content input by the operator 1. The operation information management unit 43 transmits, to the operation history acquisition unit 41 in time series, the information input to the operation panel 4 by the operator 1, and the operation history acquisition unit 41 records the received information as the operation information. The operation information is described below with reference to FIG. 5A and the like.

When the operation information input to the operation panel 4 is transmitted and the equipment 22 operates, the state of the equipment 22 changes. The change in the state of the equipment 22 is transmitted to the operation panel 4 via the PLC 20. For example, information regarding the opened and closed state of the safety door 225 is transmitted from an opening and closing sensor of the safety door 225 to the operation panel 4 via the PLC 20. As information regarding a state such as the presence or absence of the workpiece and a position of the workpiece, a detection result of the sensor 223 and an image captured by the camera 224 are transmitted to the operation panel 4 via the PLC 20. The state information regarding the equipment 22, which is transmitted from the PLC 20 to the operation panel 4, is managed by the state information management unit 44.

In addition, the operator 1 may perform work on the equipment 22 separately from the input operation on the operation panel 4 which is the input device. Examples of the work include preparation for starting the operation of the production device 2, handling an operation error occurring in the equipment 22, inspecting the equipment 22, and repairing the equipment 22. Such work can include individual work performed without using the operation panel 4, such as manually opening and closing the safety door 25, setting the workpiece in the equipment 22, taking out the workpiece from the equipment 22, cleaning the inside of the equipment 22, and replacing a part of the equipment 22.

When the operator 1 performs the work, the state of the equipment 22 changes, and the change is reflected in the information regarding the state of the equipment 22, the information being transmitted from the PLC 20 to the operation panel 4. For example, information regarding the opened and closed state of the safety door 225 is transmitted from the opening and closing sensor of the safety door 225 to the operation panel 4 via the PLC 20. As the information regarding the state such as the presence or absence of the workpiece and the position of the workpiece, the detection result of the sensor 223 and the image captured by the camera 224 are transmitted to the operation panel 4 via the PLC 20.

The state information regarding the equipment 22, which is transmitted from the PLC 20 to the operation panel 4, is managed by the state information management unit 44. The state information management unit 44 can cause the display unit 40 to display the information regarding the state of the equipment 22. The operator 1 can confirm the state of the production device 2 by viewing the information displayed on the display unit 40. The state information management unit 44 transmits the information regarding the state of the equipment 22 to the state change history acquisition unit 42 in time series, and the state change history acquisition unit 42 records a history of a state change of the equipment 22 as state change information. The state change information is described below with reference to FIG. 5B and the like.

### Display on Display Unit

A mode of the information displayed on the display unit 40 in the input device (operation panel 4) according to the embodiment will be described. The display screens described below with reference to the drawings are examples, and it goes without saying that the embodiment of the present disclosure is not limited to the examples. As described below, the operation panel 4 can display various screens in which the operation information and the state change information are associated with each other on the display unit 40.

### Example of Screen for Operating Production Device

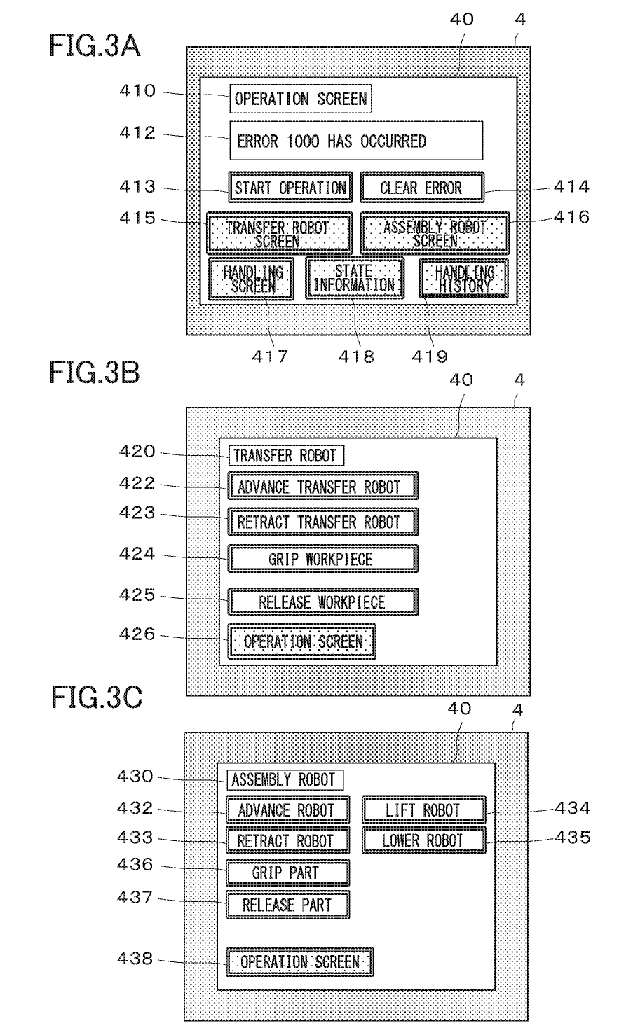

FIG. 3A is a view illustrating an example of a display screen displayed on the display unit 40 of the operation panel 4 when operating the production device 2. Displayed components and functions thereof will be described in order.

A label 410 displays a screen name and is displayed as “operation screen” in the illustrated example. A button 413 is a button that is selected on the screen to transmit a start command for starting the operation of the production device 2 from the operation panel 4 to the PLC 20.

A label 412 is a field for displaying error information in a case where an error occurs in the production device 2. A button 414 is a button that is selected on the screen to cause the production device 2 to attempt to clear the error. When the button 414 is selected, the error is cleared if an error clearing condition is satisfied, and the error information of the label 412 is updated.

A button 415 is a button that is selected on the screen to transition the display screen to a transfer robot operating screen (FIG. 3B) described below. A button 416 is a button that is selected on the screen to transition the display screen to an assembly robot operating screen. A button for transitioning to an operating screen of an individual device, such as the button 415 or the button 416, can be added according to the configuration of the equipment 22.

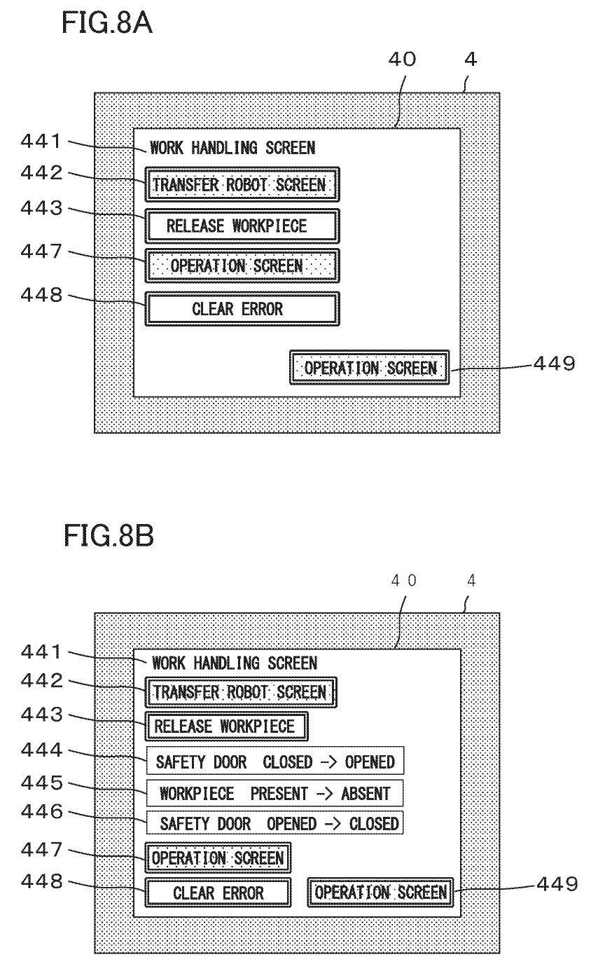

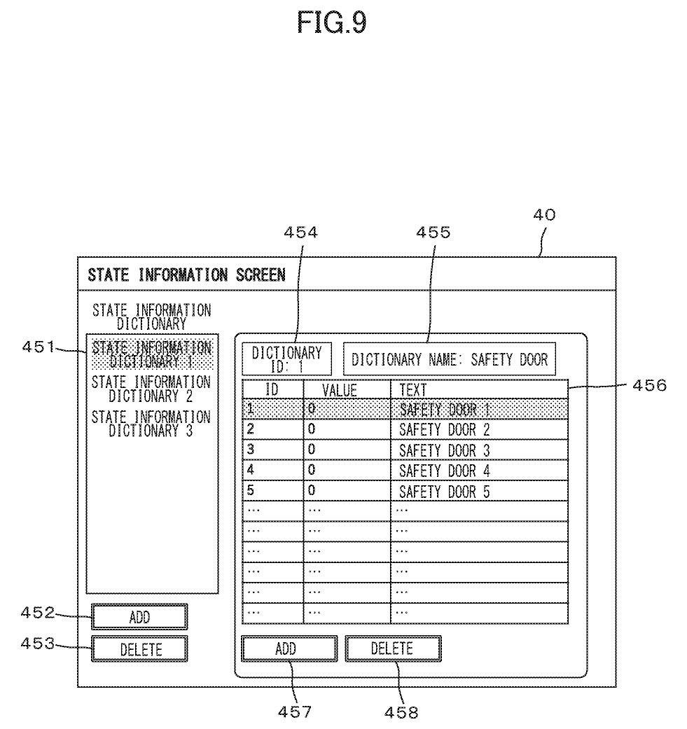

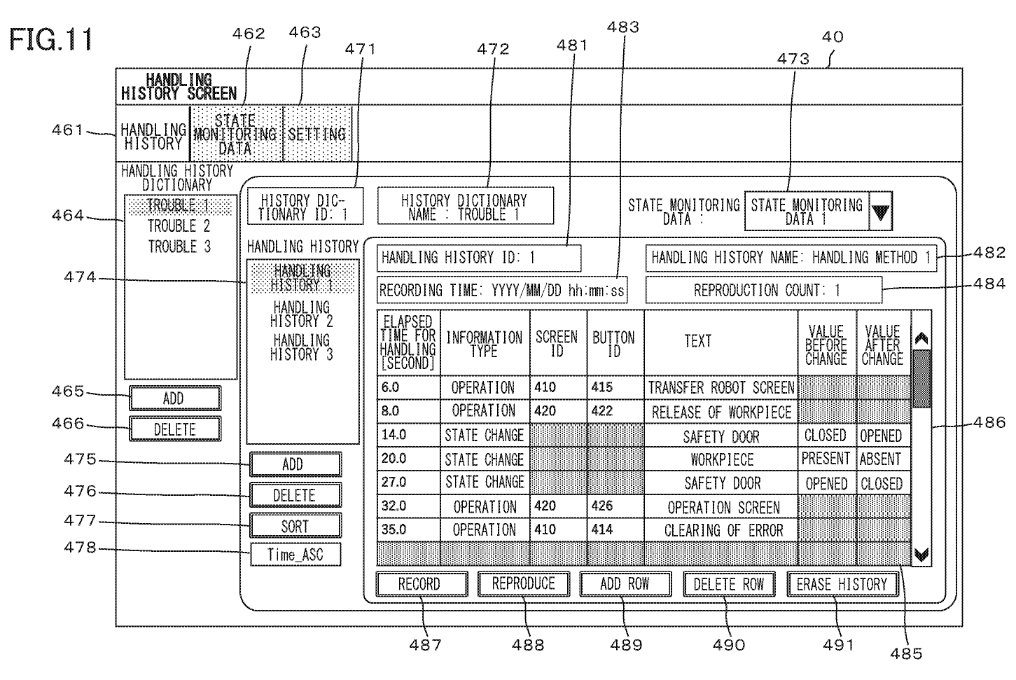

A button 417 is a button that is selected on the screen to display a work handling screen illustrated in FIG. 8B. A button 418 is a button that is selected on the screen to display a state information screen illustrated in FIG. 9. A button 419 is a button that is selected on the screen to display a handling history screen illustrated in FIG. 11.

### Example of Screen for Operating Transfer Robot

FIG. 3B is a view illustrating an example of a display screen displayed on the display unit 40 of the operation panel 4 when operating the transfer robot 221 of the production device 2. Displayed components and functions thereof will be described in order. The operating screen illustrated in FIG. 3B is not limited to the operation screen for the transfer robot 221, and may be added according to the configuration of the equipment 22.

A label 420 displays a screen name and is displayed as “transfer robot” in the illustrated example. A button 422 is a button that is selected on the screen to transmit, from the operation panel 4 to the PLC 20, a command to move the transfer robot 221 to an advanced position. A button 423 is a button that is selected on the screen to transmit, from the operation panel 4 to the PLC 20, a command to move the transfer robot 221 to a retracted position. A button 424 is a button that is selected on the screen to transmit, from the operation panel 4 to the PLC 20, a command to cause the transfer robot 221 to grip the workpiece 23. A button 425 is a button that is selected on the screen to transmit, from the operation panel 4 to the PLC 20, a command to cause the transfer robot 221 to release the workpiece 23. A button 426 is a button selected on the screen to transition the display screen to the operation screen illustrated in FIG. 3A.

### Example of Screen for Operating Assembly Robot

FIG. 3C is a view illustrating an example of a display screen displayed on the display unit 40 of the operation panel 4 when operating the assembly robot 222 of the production device 2. Displayed components and functions thereof will be described in order.

A label 430 displays a screen name and is displayed as “assembly robot” in the illustrated example. A button 432 is a button that is selected on the screen to transmit, from the operation panel 4 to the PLC 20, a command to move the assembly robot 222 to an advanced position. A button 433 is a button that is selected on the screen to transmit, from the operation panel 4 to the PLC 20, a command to move the assembly robot 222 to a retracted position. A button 434 is a button that is selected on the screen to transmit, from the operation panel 4 to the PLC 20, a command to lift the assembly robot 222. A button 435 is a button that is selected on the screen to transmit, from the operation panel 4 to the PLC 20, a command to lower the assembly robot 222. A button 436 is a button that is selected on the screen to transmit, from the operation panel 4 to the PLC 20, a command to cause the assembly robot 222 to grip a part related to assembly work. A button 437 is a button that is selected on the screen to transmit, from the operation panel 4 to the PLC 20, a command to cause the assembly robot 222 to release the part related to the assembly work. A button 438 is a button that is selected on the screen to transition the display screen to the operation screen illustrated in FIG. 3A.

### Example of Procedure and Screen for Error Handling Work

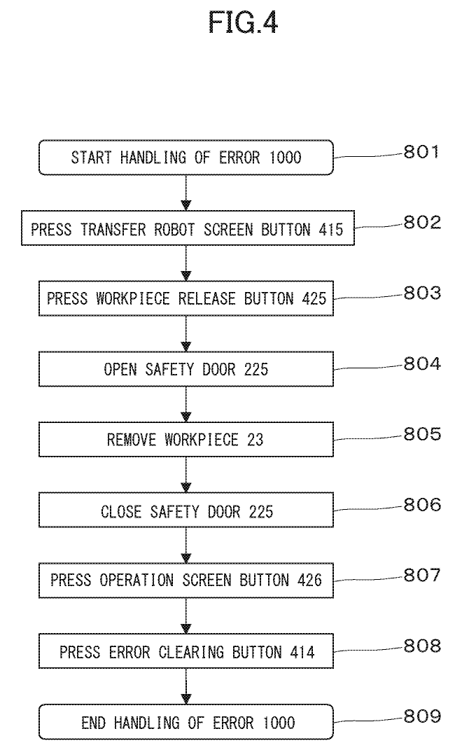

A handling procedure when an error occurs in the production device 2 and a screen displayed on the operation panel 4 at that time will be described with an example. FIG. 4 is a flowchart illustrating a handling procedure when an error occurs in the production device 2 according to the embodiment. An exemplified error 1000 is assumed to be an error that occurs in a case where the transfer robot 221 fails to grip the workpiece 23 during the operation of the production device 2. It goes without saying that a handling procedure (flowchart) different from that in the example is used according to a type of the error occurring in the production device 2.

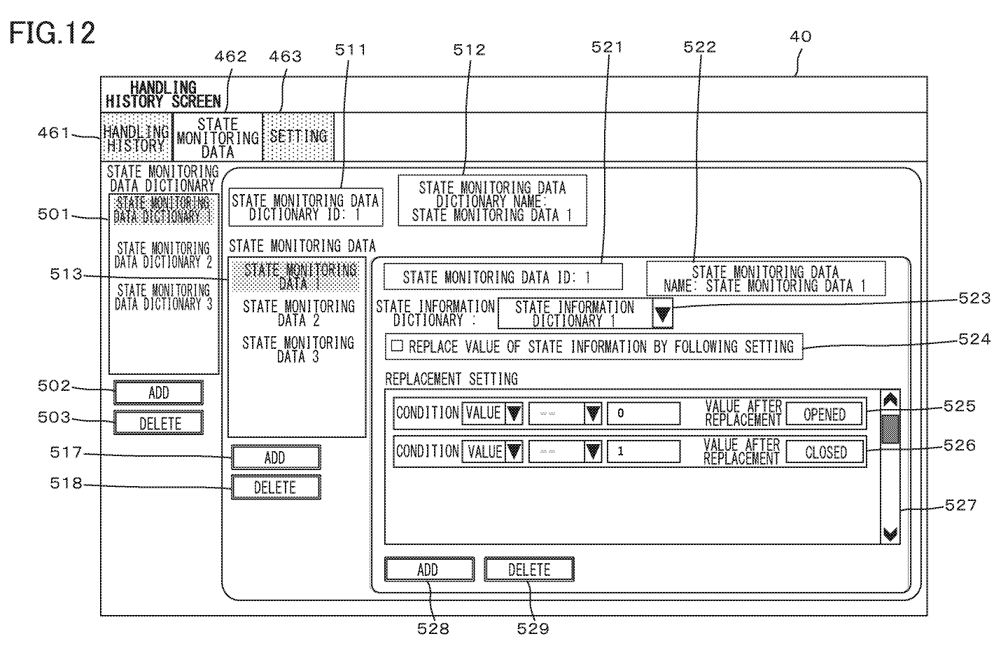

In step 801, the operator 1 starts handling work for the error 1000. A condition for starting a work flow illustrated in FIG. 4 is not limited to the occurrence of the error 1000. For example, the operator 1 may start the work flow illustrated in FIG. 4 when a button 552 on a handling recording screen illustrated in FIG. 12 is pressed (selected). FIG. 12 is described below.

In step 802, after confirming the label 412 of the error information displayed on the display unit 40 of the operation panel 4 illustrated in FIG. 3A, the operator 1 presses (selects) the button 415 for displaying the transfer robot screen. As a result, the transfer robot screen illustrated in FIG. 3B is displayed on the display unit 40 of the operation panel 4.

In step 803, the operator 1 presses (selects) the button 425 for releasing the workpiece on the display screen. As a result, the command for releasing the workpiece is transmitted from the PLC 20 to the transfer robot 221, and the transfer robot 221 performs an operation according to the command (for example, opening a hand gripping the workpiece).

In step 804, the operator 1 manually opens the safety door 225. In step 805, the operator 1 manually removes the workpiece 23. In step 806, the operator 1 manually closes the safety door 225.

When it is confirmed that the operation of releasing the workpiece has ended (that is, the state change of the equipment) using the sensor 223 or the camera 224, the state information is transmitted from the PLC 20 to the operation panel 4. The operation panel 4 can display the operation information (workpiece release) input by the operator 1 and the state change information on the display unit 40 in association with each other. From the display screen of the display unit 40, the operator 1 can easily confirm that the state of the transfer robot 221 has changed and can safely shift to the next operation procedure.

Since the removal of the workpiece that has caused the error 1000 is completed by the work in steps 804 to 806, the operator 1 performs a procedure for restarting the operation of the production device 2. In step 807, the operator 1 selects the button 426 (a button for displaying the operation screen) on the transfer robot screen in FIG. 3B. As a result, the operation screen illustrated in FIG. 3A is displayed on the display unit 40 of the operation panel 4.

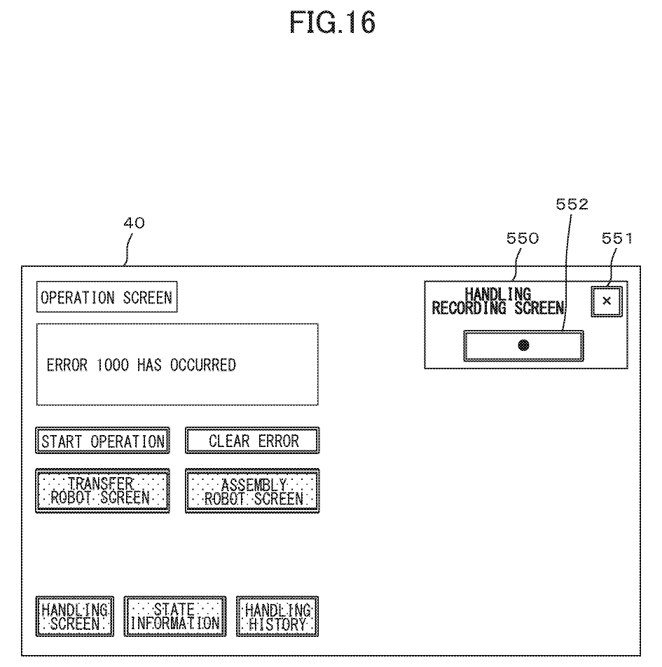

In step 808, the operator 1 presses (selects) the button 414 for clearing the error, which is displayed on the operation screen. When the button 414 is pressed in a state in which the workpiece that has caused the error 1000 is removed from the production device 2, the error 1000 is cleared, and in step 809, the operator 1 ends the work for the error 1000. A condition for ending the work flow illustrated in FIG. 4 is not limited to the clearing of the error 1000. For example, the work flow illustrated in FIG. 4 may be ended when the button 552 on the handling recording screen illustrated in FIG. 16 is pressed (selected) again. FIG. 16 is described below.

Next, data handled by the operation panel 4 in the work for handling the error 1000 will be described. FIG. 5A is a diagram illustrating operation information data obtained by recording the operation information input to the operation panel 4 by the operator 1 in time series, by the operation history acquisition unit 41 (FIG. 2) in a table format. FIG. 5B is a diagram illustrating state change information data obtained by recording the state information of the equipment 22 acquired by the operation panel 4 from the PLC 20 in time series, by the state change history acquisition unit 42 (FIG. 2) in a table format.

In the operation information data illustrated in FIG. 5A, an elapsed time 650 for handling is data of a time (unit: second) elapsed from the start of handling of the error 1000, and the illustrated value is an example.

A column 651 is data indicating whether or not an input operation of selecting the button 414 for clearing the error has been performed on the operation screen of FIG. 3A. “1” indicates that the input operation for selection has been performed, and “0” indicates that the input operation for selection has not been performed. An operation 608 exemplifies that the error clearing button 414 has been selected in step 808 of FIG. 4.

A column 652 is data indicating whether or not an input operation of selecting the button 415 for transitioning to the transfer robot screen has been performed on the operation screen of FIG. 3A. “1” indicates that the input operation for selection has been performed, and “0” indicates that the input operation for selection has not been performed. An operation 602 exemplifies that the input operation of selecting the button 415 on the transfer robot screen has been performed in step 802 of FIG. 4.

A column 653 is data indicating whether or not an input operation of selecting the button 422 for advancing the transfer robot has been performed on the transfer robot screen in FIG. 3B. “1” indicates that the input operation for selection has been performed, and “0” indicates that the input operation for selection has not been performed.

A column 654 is data indicating whether or not an input operation of selecting the button 423 for retracting the transfer robot has been performed on the transfer robot screen in FIG. 3B. “1” indicates that the input operation for selection has been performed, and “0” indicates that the input operation for selection has not been performed.

A column 655 is data indicating whether or not an input operation of selecting the button 424 for gripping the workpiece has been performed on the transfer robot screen in FIG. 3B. “1” indicates that the input operation for selection has been performed, and “0” indicates that the input operation for selection has not been performed.

A column 656 is data indicating whether or not an input operation of selecting the button 425 for releasing the workpiece has been performed on the transfer robot screen in FIG. 3B. “1” indicates that the input operation for selection has been performed, and “0” indicates that the input operation for selection has not been performed. An operation 603 exemplifies that the input operation of selecting the button 425 for releasing the workpiece has been performed in step 803 of FIG. 4.

A column 657 is data indicating whether an input operation of selecting the button 426 for displaying the operation screen has been performed on the transfer robot screen in FIG. 3B. “1” indicates that the input operation for selection has been performed, and “0” indicates that the input operation for selection has not been performed. An operation 607 exemplifies that the operation of selecting the button 426 on the operation screen has been performed in step 807 of FIG. 4.

In the state change information data illustrated in FIG. 5B, an elapsed time 650 for handling is the same as the elapsed time 650 for handling in the operation information data of FIG. 5A, and is data of a time (unit: second) elapsed from the start of handling for the error 1000.

A column 661 is data indicating whether or not the error 1000 is occurring. “1” indicates that the error 1000 is occurring, and “0” indicates that the error 1000 is not occurring. The work described with reference to FIG. 4 may be started using a state change 601 indicating that the error 1000 has occurred as a trigger. In addition, a state change 609 indicating that the error 1000 has been cleared may occur when the button 414 is pressed in step 808 of FIG. 4.

A column 662 is data indicating the opened and closed state of the safety door 225, and “1” indicates a closed state and “0” indicates an opened state. A state change 604 indicates that work of opening the safety door 225 has been performed in step 804 of FIG. 4. A state change 606 exemplifies that work of closing the safety door 225 has been performed in step 806 of FIG. 4.

A column 663 is data indicating a state of detection of the workpiece by the sensor 223, and “1” indicates that the workpiece is detected, and “0” indicates that the workpiece is not detected. A state change 605 exemplifies that work of removing the workpiece 23 has been performed in step 805 of FIG. 4.

### Display in Which Operation Information and State Change Information Are Associated with Each Other

The operation panel 4 serving as the input device according to the embodiment can generate data in which the operation information input to the operation panel 4 and the state change information of the equipment 22 acquired from the PLC 20 are associated with each other and display the data on the display unit 40.

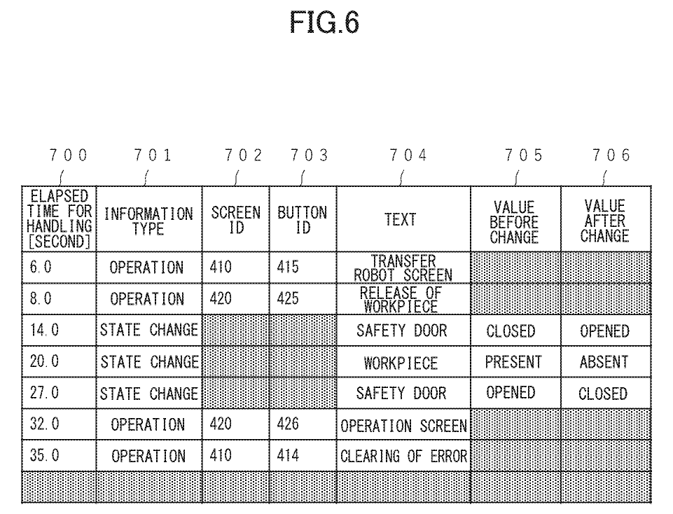

FIG. 6 is a data list illustrating an example of the data in which the operation information and the state change information are associated with each other in a table format, the data being generated by the operation panel 4. Specifically, the data list is a data list in which the operation information input to the operation panel 4 by the operator 1 and the state change information of the equipment 22 acquired from the production device 2 are associated with each other based on the elapsed time for handling from the start to the end of the handling for the error 1000.

A column 700 indicates data of the elapsed time (unit: second) from the start of handling the error 1000, and corresponds to the elapsed time 650 for handling in FIGS. 5A and 5B. Numerical values in FIG. 6 exemplify those in a case where an operator who is skilled in error handling handles the error. A column 701 is data indicating an information type, “operation” indicates that the data is the operation information, and “state change” indicates that the data is the state change information.

In a case where the information type is the operation information, a column 702 represents a screen ID of a screen on which a button for the input operation by the operator is present. The screen ID is a value for uniquely identifying each of all the screens displayable on the operation panel 4. In a case where the information type is the state change information, there is no data in the column 702.

In a case where the information type is the operation information, a column 703 indicates a button ID of a button for which the input operation has been performed. The button ID is a value for uniquely identifying each of all the buttons displayable on the operation panel 4. In a case where the information type is the state change information, there is no data in the column 703.

With the pieces of information of the screen ID in the column 702 and the button ID in the column 703, it is possible to uniquely identify which button on which screen the input operation has been performed for.

A column 704 is data of a text (character string) displayed on an operated button in a case where the information type is the operation information, and is data of a text (character string) indicating an information source of the state information in a case where the information type is the state change information.

A column 705 is a value before the state change in a case where the information type is the state change information, and there is no data in the column 705 in a case where the information type is the operation information. A column 706 is a value after the state change in a case where the information type is the state change information, and there is no data in the column 706 in a case where the information type is the operation information.

The values of the column 705 and the column 706 are acquired from the data of the state information illustrated in FIG. 5B. In a case where the original data is a numerical value such as “1” or “0”, the numerical value may be replaced with a character string that can be easily recognized by the operator by a replacement setting method described below with reference to FIG. 12. The values of the column 705 and the column 706 are not limited to 1-bit data such as “0” and “1”, and may be other numerical values or character strings expressed by 16 bits or 32 bits.

In the data list illustrated in FIG. 6, an input operation performed on the operation panel 4 by the skilled operator at the time of handling the error and an operation performed on the equipment 22 are associated with each other based on the elapsed time. Therefore, by displaying the data list on the display unit 40, an error handling procedure of the skilled operator can be shared among the operators. In addition, generating and displaying data regarding error handling performed by an unskilled operator in a similar manner clarifies a difference in procedure from the skilled operator, thereby contributing to improvement in a work procedure of the unskilled operator.

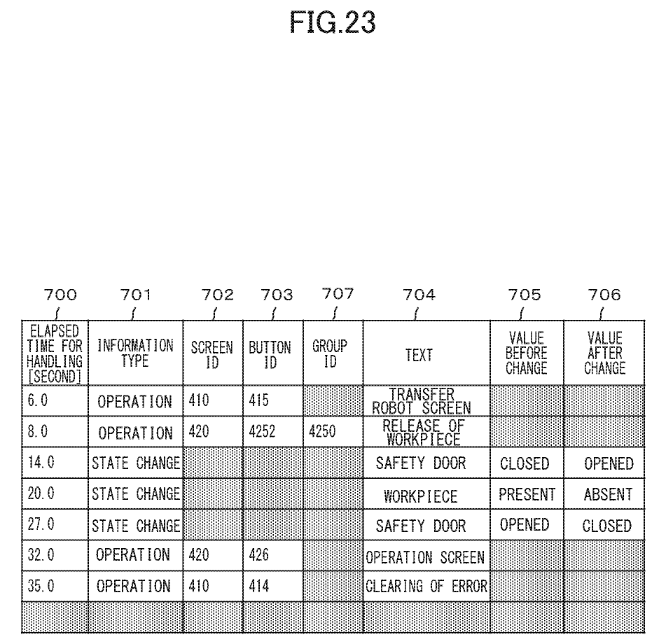

The data list illustrating the data in which the operation information and the state change information are associated with each other in a table format is not limited to the example of FIG. 6. For example, as illustrated in FIG. 23, a column 707 may be added to the data list illustrated in FIG. 6. The column 707 represents a group ID of a group to which a button having the button ID of the column 703 belongs. The group ID is a value for uniquely identifying a group to which the button of each screen of the operation panel 4 belongs. In a case where the button having the button ID of the column 703 does not belong to a group, or in a case where the information type of the column 701 is “state change”, there is no data in the column 707.

### Work Handling Screen

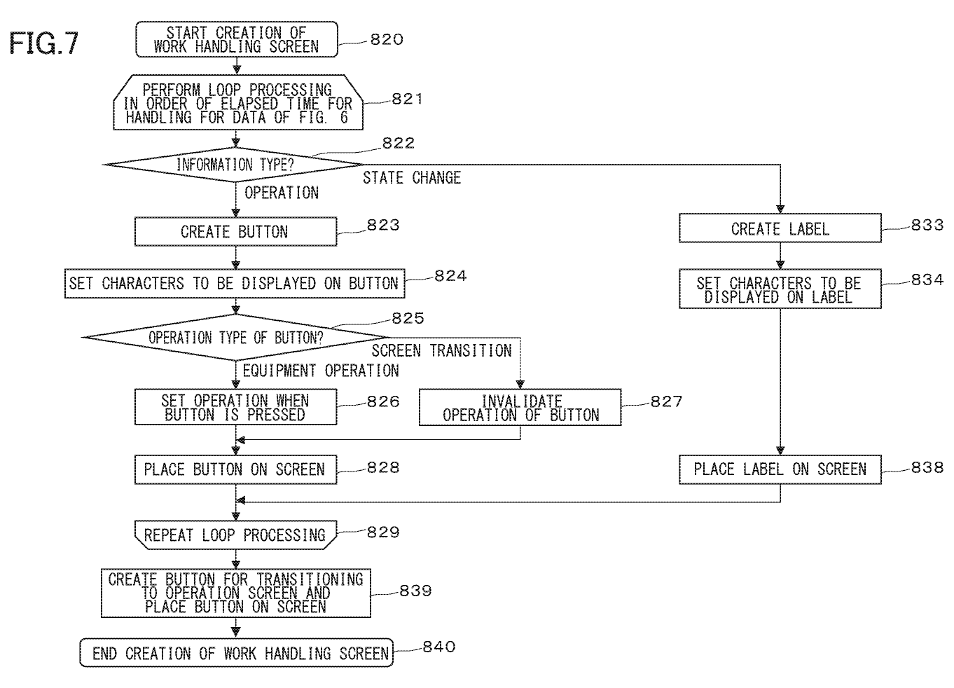

The operation panel 4 serving as the input device according to the embodiment can create and display the work handling screen for supporting the operator based on the data list illustrated in FIG. 6. FIG. 7 is a flowchart illustrating an example of a procedure of creating the work handling screen using the operation information and the state change information.

First, in step 820, the creation of the work handling screen starts. In step 821, loop processing starts in order of the elapsed time for handling for the data list of FIG. 6. In step 822, the processing branches based on the information type of target data as a determination condition. In a case where the information type is “operation”, the processing proceeds to step 823, and in a case where the information type is “state change”, the processing proceeds to step 833.

In a case where it is determined in step 822 that the information type is “operation”, the processing proceeds to step 823, and a button is created. In subsequent step 824, a text related to the target data is set as characters to be displayed on the button. In step 825, the processing branches based on an operation type of the target data as a determination condition. In a case where the operation type is “equipment operation”, the processing proceeds to step 826, and in a case where the operation type is “screen transition”, the processing proceeds to step 827.

In a case where the operation type is “equipment operation”, an operation performed when the button is pressed (when the button is selected) is set in step 826. In a case where the operation type is “screen transition”, a setting for invalidating the operation of the button is made in step 827.

In step 828 following step 826 or step 827, the button is placed on the screen. In step 829, the processing returns to step 821, and the loop processing is repeated for the next data list.

In a case where the information type is “state change” in step 822, a label is created in step 833. In step 834, the text of the target data is set as characters to be displayed on the label. In step 838, the label is placed on the screen. In step 829, the processing returns to step 821, and the loop processing is repeated for the next data list.

When the loop processing of steps 821 to 829 ends, the button for transitioning to the operation screen is created and placed on the screen in step 839. Then, the creation of the work handling screen ends in step 840.

The work handling screen created by the above procedure will be exemplified. When the processing of the flowchart of FIG. 7 is performed for the data list of FIG. 6, the work handling screen exemplified below is created. FIG. 8A is a diagram illustrating the work handling screen created using only the operation information, and FIG. 8B is a diagram illustrating the work handling screen created using both the operation information and the state change information.

A label 441 is a label that displays a screen name. A button 442 indicates a button for transitioning to the robot operation screen. On the work handling screen, a screen transition operation performed when the button 442 is pressed (selected) is disabled. Similarly to the button 425 on the transfer robot screen in FIG. 3B, an input operation of pressing (selecting) a button 443 is performed to transmit, to the transfer robot 221, a command for releasing the workpiece 23.

A label 444 indicates that the state of the safety door changes from “closed” to “opened”. A label 445 indicates that the state of the workpiece changes from “present” to “absent”.

A label 446 indicates that the state of the safety door changes from “opened” to “closed”.

A button 447 indicates a button for transitioning to the operation screen. On the work handling screen, a screen transition operation performed when the button 447 is pressed is disabled. Similarly to the button 414 on the operation screen in FIG. 3A, a button 448 is pressed (selected) to clear the error when the error clearing condition is satisfied. When a button 449 is pressed (selected), the display transitions to the operation screen.

In the work handling screen illustrated in FIG. 8B, the operation information related to the input operation on the operation panel 4 is indicated by a double frame, and the state change information related to the state change of the equipment 22 is indicated by a single frame. Moreover, such pieces of information are arranged in descending order from the top according to a required processing sequence. By displaying such a work handling screen, the operator can very easily recognize the input operation or work to be processed in order. Therefore, even in the case of unfamiliar error processing, the operator can reliably perform the input operation on the operation panel 4 and the work on the equipment 22 in a short time.

In the work handling screen illustrated in FIGS. 8A or 8B, in order to allow the operator to easily recognize the progress of the processing, a display image may be changed by, for example, changing a color, a character size, or a font weight between a portion where the input operation or work has been completed and a portion where the input operation or work has not been completed. Alternatively, the display image may be changed by, for example, changing the color, changing the character size, or flashing for the input operation or work to be performed next by the operator.

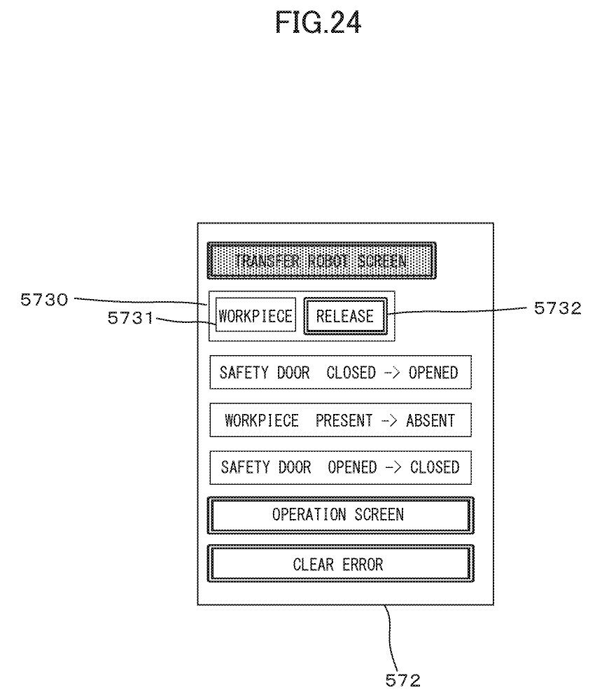

The work handling screen is not limited to the example of FIGS. 8A and 8B. For example, the work handling screen may include a region 572 illustrated in FIG. 24. The region 572 is a region where the work handling screen created using the data list illustrated in FIG. 23 is displayed.

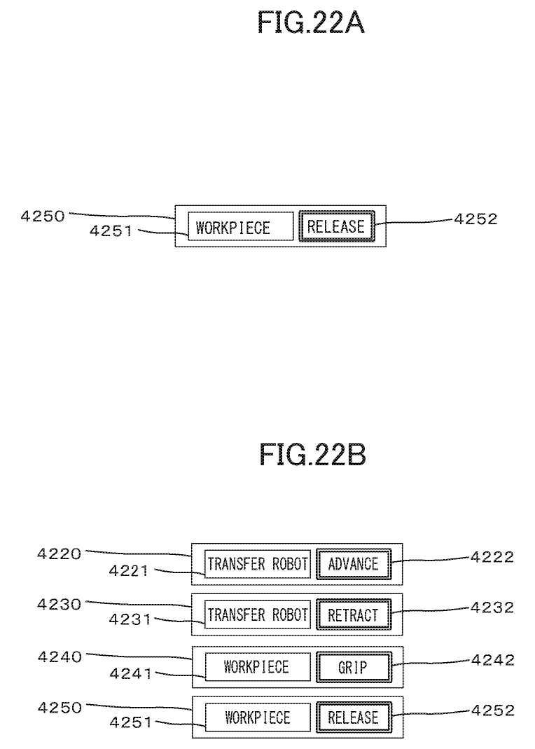

In a case where there is data in the column 707 of FIG. 23, a group having the group ID of the column 707 is displayed on the work handling screen. A group 5730 in FIG. 24 displays a group 4250 in FIG. 23. A label 5731 in FIG. 24 displays a label 4251 in FIG. 22B. A button 5732 in FIG. 24 displays a button 4252 in FIG. 23.

### State Information Screen

The operation panel 4 serving as the input device according to the embodiment can create and display the state information screen by using a state information dictionary for supporting the operator. The state information dictionary is one data having a plurality of pieces of state information, and is an example of a state information management method.

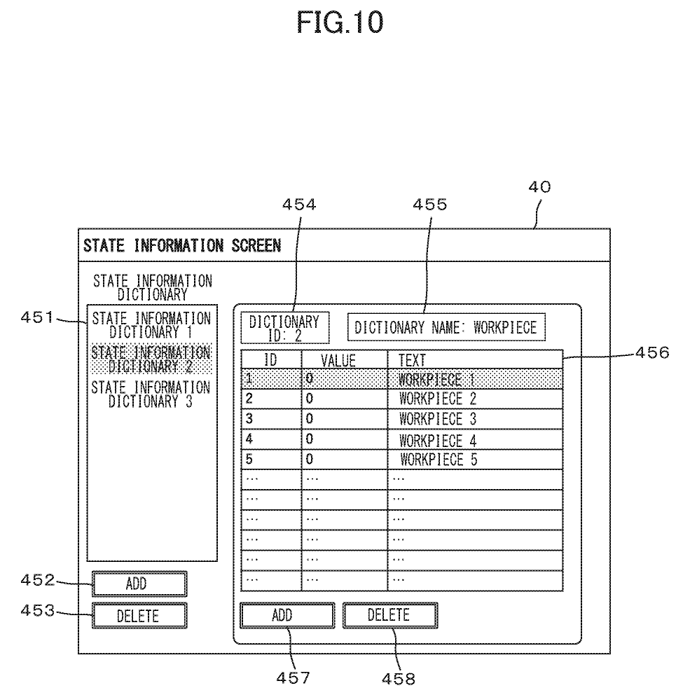

FIGS. 9 and 10 illustrate the same type of state information screens in which different state information dictionaries are selected. FIG. 9 illustrates a case where a state information dictionary 1 is selected, and FIG. 10 illustrates a case where a state information dictionary 2 is selected.

A list 451 is a list of the state information dictionaries. The operator can press (select) one of the state information dictionaries displayed in the list 451 to display the selected state information dictionary.

A button 452 is a button that is pressed (selected) to add the state information dictionary to the list 451. A button 453 is a button that is pressed (selected) to delete the selected state information dictionary. The operator can arbitrarily add or delete the state information dictionary by using the button 452 and the button 453.

A label 454 is a label that displays a dictionary ID of the selected state information dictionary. The dictionary ID is a value for uniquely identifying the state information dictionary. A label 455 is a label that displays a dictionary name of the selected state information dictionary.

A data table 456 is a list that displays data having a plurality of pieces of state information. Each piece of state information described in the data table 456 includes piece of data including an ID, a value, and a text. The ID included in the state information is a value for uniquely identifying the state information. The value included in the state information is data indicating the state. The value of the state information is not limited to 1-bit data such as “0” or “1”, and may be another numerical value or character string expressed by 16 bits or 32 bits. For example, data of a numerical value other than “0” or “1”, such as analog sensor data, may also be used as the value of the state information. The text included in the state information is a character string indicating a content of the state information.

The operator can select the state information by pressing (selecting) one piece of data in the data table 456. A button 457 is a button that is pressed (selected) to add the state information to the data table 456. A button 458 is a button that is pressed (selected) to delete the selected state information. The operator can arbitrarily add or delete the state information by using the button 457 and the button 458.

On the state information screen illustrated in FIGS. 9 and 10, a list of the states that can be taken by the components of the equipment 22, such as the safety door and the workpiece, can be displayed using the state information dictionary. Therefore, the operator can register and display the state information of the equipment 22, in other words, work to be performed by the operator on the equipment 22, on the operation panel 4 without omission.

### Handling History Screen

The operation panel 4 serving as the input device according to the embodiment can create and display the handling history screen for handling a plurality of handling histories in order to support the operator. The handling history is data (the data list illustrated in FIG. 6) in which the operation information of the operator 1 and the state change information of the production device 2 are arranged in time series from the start to the end of one handling process.

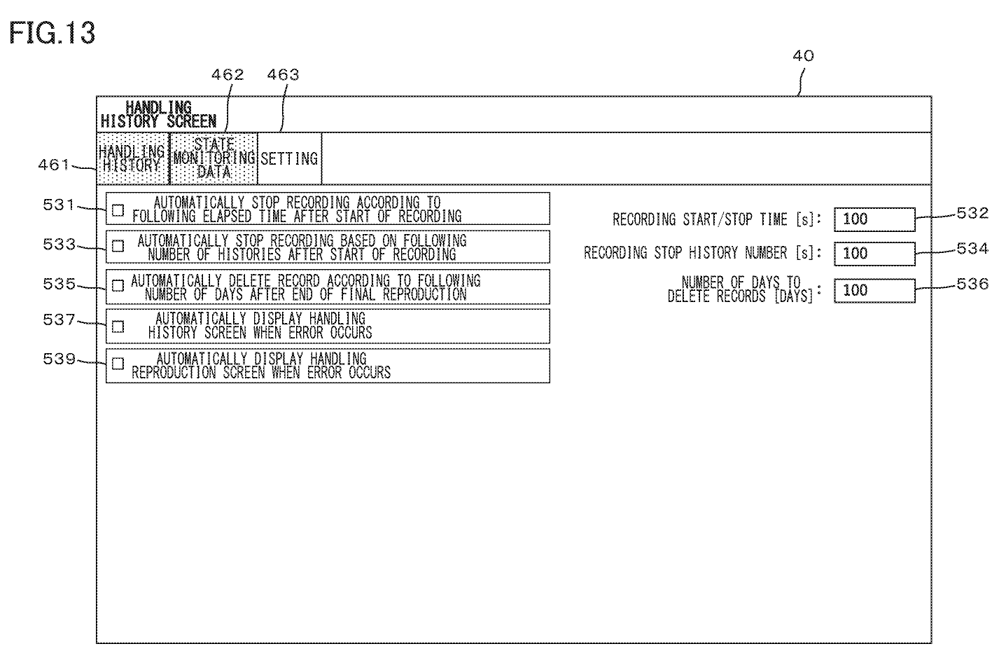

FIG. 11 is a view illustrating an example of a screen for editing the handling history on the handling history screen. FIG. 12 is a view illustrating an example of a screen for editing state monitoring data on the handling history screen. FIG. 13 is a view illustrating an example of a screen for editing a setting on the handling history screen.

In FIGS. 11, 12, and 13, tab 461, tab 462, and tab 463 are common. When the tab 461 is pressed (selected), a screen for processing the handling history is displayed on the handling history screen. When the tab 462 is pressed (selected), a screen for processing the state monitoring data is displayed on the handling history screen. When the tab 463 is pressed (selected), a screen for processing the setting is displayed on the handling history screen.

The screen for editing the handling history will be described with reference to FIG. 11. A handling history dictionary is data including a plurality of handling histories, and is an example of a handling history management method. A list 464 is a list of the handling history dictionaries. The selection of the handling history dictionary can be performed by pressing (selecting) one of the handling history dictionaries displayed in the list 464.

A button 465 is a button that is pressed (selected) to add the handling history dictionary to the list 464. A button 466 is a button that is pressed (selected) to delete the selected handling history dictionary. The operator can arbitrarily add or delete the handling history dictionary by using the button 465 and the button 466.

A label 471 is a label that displays a dictionary ID of the selected handling history dictionary. The dictionary ID is a value for uniquely identifying the handling history dictionary. A label 472 is a label that displays a dictionary name of the selected handling history dictionary.

When a selection box 473 is pressed (selected), a state monitoring data dictionary described in FIG. 12 can be selected. When the handling history dictionary refers to the state monitoring data dictionary, it is possible to set which state change information is to be acquired during recording of the handling history. A list 474 is a list of the handling histories. The selection of the handling history can be performed by pressing (selecting) one of the handling histories displayed in the list 474.

A button 475 is a button that is pressed (selected) to add the handling history to the list 474. A button 476 is a button that is pressed (selected) to delete the selected handling history. The operator can arbitrarily add or delete the handling history by using the button 475 and the button 476.

A button 477 is a button that is pressed (selected) to sort the plurality of handling histories displayed in the list 474 according to a specific condition. Here, examples of the specific condition include an ascending order and a descending order of a handling history ID, the elapsed time for handling, a reproduction count, and the like.

A label 478 is a label that displays a condition for sorting the plurality of handling histories. A label 481 is a label that displays the handling history ID of the selected handling history. The handling history ID is a value for uniquely identifying the handling history. A label 482 is a label that displays a handling history name of the selected handling history. A label 483 is a label that displays a date and time when the selected handling history is recorded. A label 484 is a label that displays a reproduction count of the selected handling history. Here, reproduction means that the handling history is executed again after recording.

Similarly to the data list illustrated in FIG. 6, a data table 485 is a diagram illustrating an example of handling history data. When the data table 485 is pressed (selected), a cell at a pressed (selected) position can be selected. A value of the cell selected in the data table 485 may be re-inputtable.

A scroll bar 486 has a function of displaying a portion of the data table 485 that cannot be fully displayed by being scrolled. A button 487 is a button that is pressed (selected) to display a handling recording screen illustrated in FIG. 16 for the handling history selected in the list 474 and hide the handling history screen.

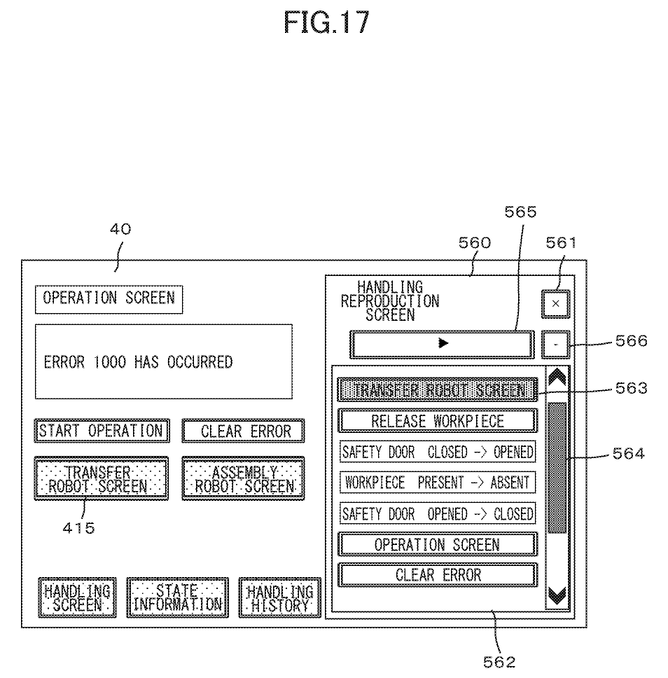

A button 488 is a button that is pressed (selected) to display a handling reproduction screen illustrated in FIG. 17 for the handling history selected in the list 474 and hide the handling history screen. A button 489 is a button that is pressed (selected) to add a row for a row of the cell selected in the data table 485. A button 490 is a button that is pressed (selected) to delete a row of the cell selected in the data table 485. A button 491 is a button that is pressed (selected) to erase handling history data selected in the list 474.

The screen for editing the state monitoring data will be described with reference to FIG. 12. The state monitoring data is setting data for acquiring the state change information of the production device 2. The state monitoring data dictionary is data including a plurality of pieces of state monitoring data, and is an example of a state monitoring data management method.

A list 501 is a list of the state monitoring data dictionaries. The selection of the state monitoring data dictionary can be performed by pressing (selecting) one of the state monitoring data dictionaries displayed in the list 501.

A button 502 is a button that is pressed (selected) to add the state monitoring data dictionary to the list 501. A button 503 is a button that is pressed (selected) to delete the selected state monitoring data dictionary. The operator can arbitrarily add or delete the state monitoring data dictionary by using the button 502 and the button 503.

A label 511 is a label that displays a dictionary ID of the selected state monitoring data dictionary. The dictionary ID is a value for uniquely identifying the state monitoring data dictionary. A label 512 is a label that displays a dictionary name of the selected state monitoring data dictionary.

A list 513 is a list of the pieces of state monitoring data. By pressing (selecting) one of the pieces of state monitoring data displayed in the list 513, the pressed state monitoring data can be selected. A button 517 is a button that is pressed (selected) to add the state monitoring data to the list 513. A button 518 is a button that is pressed (selected) to delete the selected state monitoring data.

A label 521 is a label that displays a state monitoring data ID of the selected state monitoring data. The state monitoring data ID is a value for uniquely identifying the state monitoring data. A label 522 is a label that displays a state monitoring data name of the selected state monitoring data.

When a selection box 523 is pressed (selected), the state information dictionary described with reference to FIGS. 9 and 10 can be selected. When the state monitoring data refers to the state information dictionary, it is possible to set which state information is to be acquired.

A check box 524 is checked to enable a function of replacing the value of the state information acquired by the state monitoring data with another value. Each of a replacement setting 525 and a replacement setting 526 is an example of a replacement setting. The replacement setting 525 indicates a setting for replacing the value with “opened” in a case where the value of the state information is 0. The replacement setting 526 indicates a setting for replacing the value with “closed” in a case where the value of the state information is 1.

A scroll bar 527 has a function of displaying the replacement setting that cannot be fully displayed by being scrolled. A button 528 is a button that is pressed (selected) to add the state monitoring data to the list 513. A button 529 is a button that is pressed (selected) to delete the selected state monitoring data.

An example of editing a setting screen in the handling history screen will be described with reference to FIG. 13. The setting screen for the handling history is a screen for setting a method of recording, deleting, or displaying the handling history.

A check box 531 is checked to enable a function of automatically stopping recording according to an elapsed time after the start of the recording of the handling history. An input box 532 can set a time to be used for the function of the check box 531. A check box 533 is checked to enable a function of automatically stopping recording based on the number of handling histories after the start of recording of the handling history. An input box 534 can set the number of histories to be used for the function of the check box 531.

A check box 535 is checked to enable a function of automatically deleting the record according to an elapsed time after the end of the recording of the handling history. An input box 536 can set a time to be used for the function of the check box 535.

A check box 537 is checked to enable a function of automatically displaying the handling history screen (FIG. 11) in a case where an error occurs in the production device 2. A check box 539 is checked to enable a function of automatically displaying the handling reproduction screen (FIG. 17) in a case where an error occurs in the production device 2. The automatic display functions of the check box 537 and the check box 539 may automatically select the handling history dictionary with the dictionary ID matching an error number or may automatically display the handling history dictionary according to a condition other than the error.

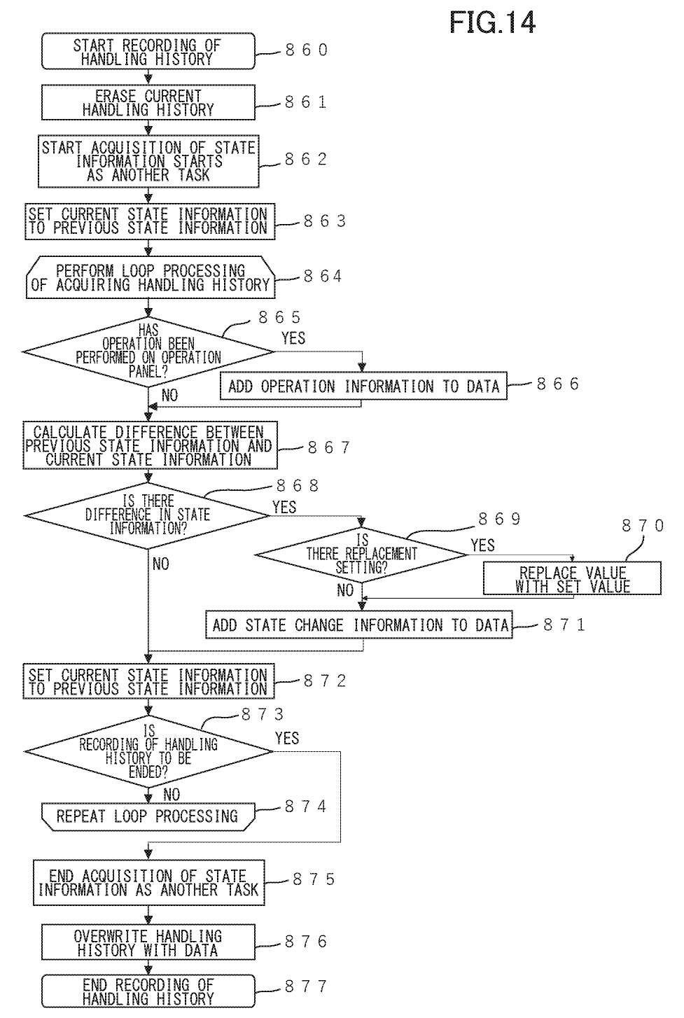

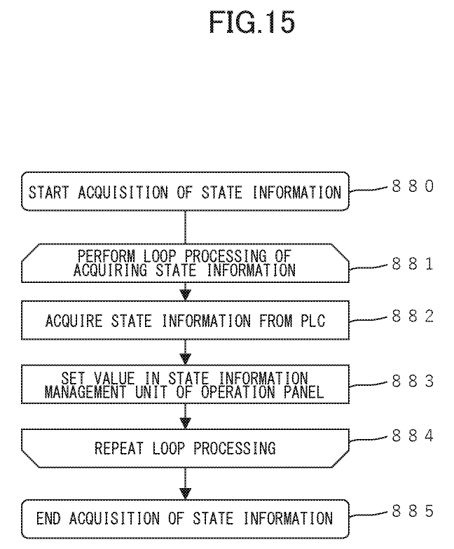

Next, a procedure of recording the handling history using the screen described above will be described. FIG. 14 is a flowchart illustrating a main flow of the procedure of recording the handling history. FIG. 15 is a flowchart of another task (acquisition of the state information) executed in the flow of FIG. 14.

FIG. 14 will be described below. First, in step 860, the recording of the handling history starts. In step 861, the current handling history is erased.

In step 862, acquisition of the state information starts as another task illustrated in the flow of FIG. 15. The reason why the acquisition of the state information is performed as another task is that the value of the state information is continuously updated during the loop processing of step 864. In step 863, the previous state information is set as the current state information. In step 864, the loop processing of acquiring the handling history starts.

In step 865, the processing branches based on whether or not an operation has been performed on the display unit 40 of the operation panel 4. In a case where an operation has not been performed, the processing proceeds to step 867. In a case where an operation has been performed, the operation information is added to the handling history data in step 866, and the processing proceeds to step 867. In step 867, a difference between the previous state information and the current state information is calculated as the state change information. In step 868, the processing branches based on whether or not there is a difference in the state information obtained in step 867. In a case where there is no difference, the processing proceeds to step 872.

In a case where there is a difference, the processing proceeds to step 869. In step 869, the processing branches based on the replacement setting of the target data. In a case where the replacement setting is “NO”, the processing proceeds to step 871, and when the replacement setting is “YES”, the processing proceeds to step 870. In step 870, a value of the target data is replaced with a set value according to the replacement setting, and the processing proceeds to step 871. In step 871, the state change information is added to the handling history data, and the processing proceeds to step 872. In step 872, the previous state information is set as the current state information.

In step 873, it is confirmed whether or not an end condition for the handling history is satisfied. In a case where the end condition is not satisfied, the processing returns from step 874 to step 864, and the loop processing is repeated. In a case where the end condition is satisfied, the processing proceeds to step 875.

In step 875, the acquisition of the state information of FIG. 15 executed as another task ends. In step 876, the handling history data is displayed in the data table 485. In step 877, the recording of the handling history ends.

Next, the acquisition of the state information executed as another task will be described with reference to a flowchart illustrated in FIG. 15. In step 880, the acquisition of the state information starts. In step 881, the loop processing of acquiring the state information starts. In step 882, the state information is acquired from the PLC 20. In step 883, the value of the state information is set in the state information management unit 44 of the operation panel 4. In step 884, the processing returns to step 881, and the loop processing is repeated. In step 885, the acquisition of the state information ends.

### Handling Recording Screen

Next, the handling recording screen will be described with reference to FIG. 16. The handling recording screen is displayed when the button 487 is pressed (selected) on the handling history screen of FIG. 11. FIG. 16 is a view illustrating an example of a handling recording screen 550 displayed on the operation screen.

When a button 551 is pressed (selected), the handling recording screen 550 is closed, and the handling history screen of FIG. 11 is displayed again. When a button 552 is pressed (selected), the recording of the handling history in step 860 of FIG. 14 starts. When the button 552 is pressed (selected) again during the execution of the flow of FIG. 14, the end condition for the handling history record of step 873 is satisfied.

### Handling Reproduction Screen

Next, the handling reproduction screen will be described with reference to FIG. 17. The handling reproduction screen is displayed when the button 488 is pressed (selected) on the handling history screen of FIG. 11. FIG. 17 is a view illustrating an example of a handling reproduction screen 560 displayed on the operation screen. Even in a case where the handling reproduction screen 560 is displayed, the other buttons displayed on the display unit 40 may be operable as usual.

A button 561 is a button that is pressed (selected) to close the handling reproduction screen 560 and re-display the handling history screen of FIG. 11. A region 562 is a region in which the work handling screen illustrated in FIG. 8B is displayed. However, the label 441 and the button 449 of FIG. 8B are not displayed in the region 562 of FIG. 17. The region 562 is created by executing the flowchart of FIG. 7. However, in step 825, the processing always proceeds to step 826, and step 839 is not performed. Similarly to the button 442 of FIG. 8B, a button 563 indicates a button that is pressed (selected) to transition the display screen to the transfer robot screen.

If a button or label displayed in the region 562 is created based on work performed on the current screen, a color of the button or label may be changed. A scroll bar 564 has a function of displaying the region 562 that cannot be fully displayed by being scrolled. A button 565 is a button that is pressed (selected) to sequentially perform operations of the buttons displayed in the region 562 according to the elapsed time for handling illustrated in the data list of FIG. 6. A button 566 is a button that is pressed (selected) to hide the region 562 and the scroll bar 564. When the button 566 is pressed (selected) in a state in which the region 562 and the scroll bar 564 are hidden, the region 562 and the scroll bar 564 are displayed again.

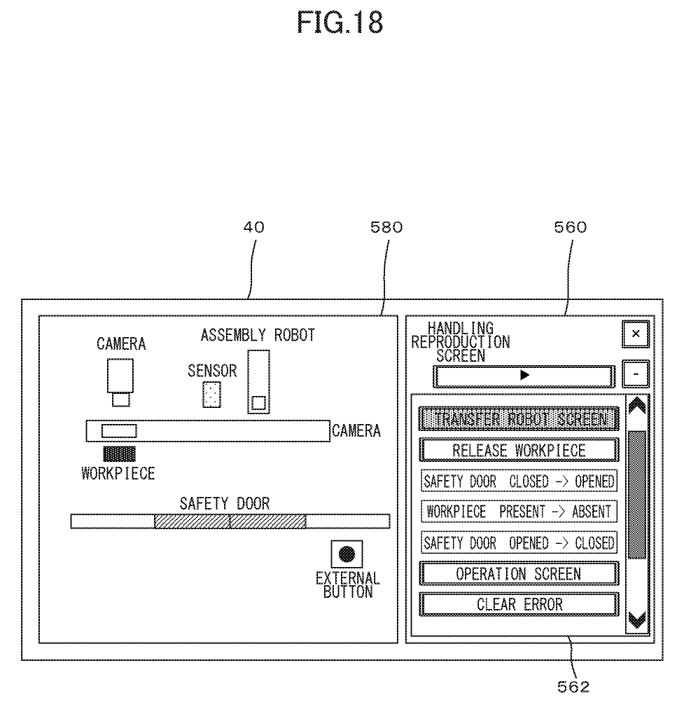

FIG. 18 is a view illustrating an example in which a screen 580 illustrating the equipment 22 which is the control target (work target) and the handling reproduction screen 560 are simultaneously displayed. In the example, the screen 580 is displayed in conjunction with the handling reproduction screen 560.

The screen 580 includes a diagram illustrating a positional relationship between the components of the equipment 22 which is the work target, and may further include the state information of the equipment 22. The inclusion of the state information means that, for example, if there is a workpiece in the equipment 22, the workpiece is illustrated, and if there is no workpiece, the workpiece is not illustrated.

### Display of Position of Operator

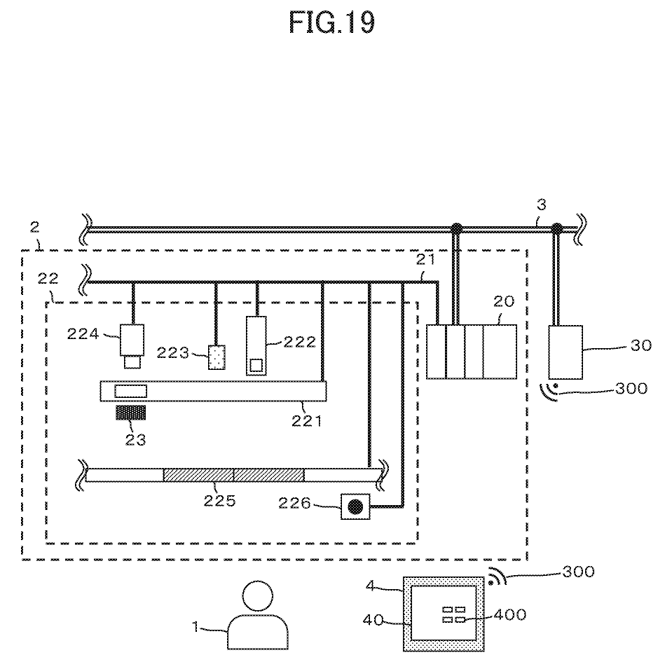

FIG. 19 is a schematic block diagram illustrating an example of a configuration in which the input device (operation panel 4) according to the embodiment communicates with the production device 2, which is the control target, by using the wireless communication device. In the production system illustrated in FIG. 19, the communication-system network 3 of the production system described with reference to FIG. 1 includes a wireless communication device 30. The operation panel 4 and the wireless communication device 30 can wirelessly communicate with each other via, for example, a radio wave 300 or an infrared ray. That is, the operation panel 4 can wirelessly communicate with the PLC 20 via a wireless communication device.

The operation panel 4 can be configured to acquire position information of the operation panel 4 with respect to the production device 2 (that is, the equipment 22) by using, for example, the radio wave 300 or the infrared ray. A method for acquiring the position information is not particularly limited. Since the operator holds the operation panel 4 and performs the input operation or work on the equipment 22, it can be said that the position information of the operation panel 4 indicates the position of the operator with respect to the equipment 22.

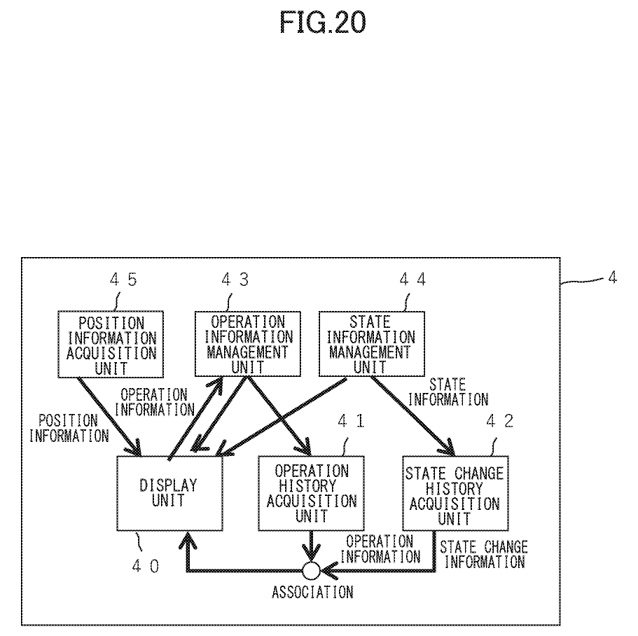

FIG. 20 is a schematic block diagram illustrating the functions of the operation panel 4 having such a configuration. The operation panel 4 illustrated in FIG. 20 includes a position information acquisition unit 45 in addition to the functional blocks described with reference to FIG. 2. The position information acquisition unit 45 acquires the position information of the operation panel 4. The display unit 40 can display the position information of the operation panel 4.

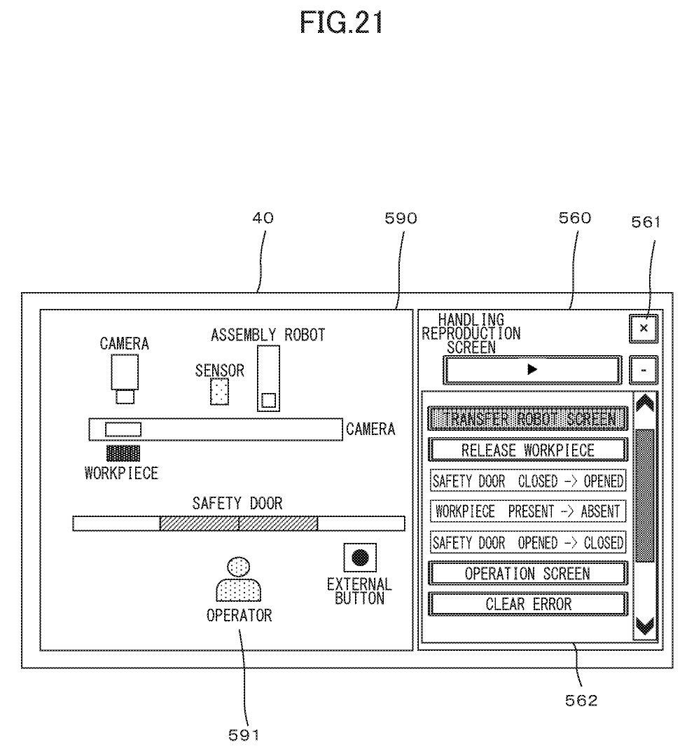

FIG. 21 is a view illustrating an example in which a screen 590 illustrating the equipment 22, which is the control target (work target), and an operator 591, and the handling reproduction screen 560 are simultaneously displayed. The screen 590 illustrates an arrangement of the components of the equipment 22 and is displayed in conjunction with the handling reproduction screen 560.

A position of the operator 591 is specified based on the position information of the operation panel 4 acquired by the position information acquisition unit 45 in FIG. 19, and is displayed as the operator 591 at the position on the display screen.

### Display Form Used on Screen

A display form used in a screen for operating the equipment on the operation panel 4 will be exemplified. The display form illustrated in FIG. 22A is an example in which the button 425 on the screen for operating the transfer robot described with reference to FIG. 3B is configured in another format such as the group 4250, the label 4251, or the button 4252.

Similarly to the button 425, the button 4252 is a button that is pressed (selected) to transmit, to the PLC 20, a command for the transfer robot 221 to release the workpiece 23. The label 4251 is a label that displays an operation target of the button 4252. The group 4250 is a group of the label 4251 and the button 4252.

In the display form illustrated in FIG. 22B, the buttons 422 to 425 on the screen for operating the transfer robot described with reference to FIG. 3B are displayed in the same format as in FIG. 22A. That is, the button 422 is configured as a group 4220, a label 4221, and a button 4222. The button 423 is configured as a group 4230, a label 4231, and a button 4232. The button 424 is configured as a group 4240, a label 4241, and a button 4242. And the button 425 is configured as the group 4250, the label 4251, and the button 4252.

As described above, the operation panel 4 according to the embodiment is configured to be able to change and edit a display format of an item that is an input operation target such that the operator can easily perform the input operation.

### FIRST EMBODIMENT

In a first embodiment, an operation panel that can support an operator to quickly complete work on equipment at a production site will be described.

The operation panel exemplified as the first embodiment is an input device including an information processing unit, a display unit, and an input unit, in which the input unit receives an input operation for controlling the equipment, and the information processing unit acquires first information regarding the control of the equipment performed by the input operation on the input unit and second information regarding a state change of the equipment caused by work performed on the equipment without using the input unit, generates, based on the acquired first information and second information, an image in which information regarding the input operation is associated with information regarding a history of the state change of the equipment caused by the input operation or the work, and displays the image on the display unit. A control method for controlling the input device, a program for causing a computer to execute the control method, and a computer-readable recording medium in which the program is recorded are also included in the present embodiment. In addition, the present embodiment also includes an article manufacturing method for manufacturing an article by controlling the equipment using the input device, the equipment being equipment capable of performing at least a part of an article manufacturing process.

Specifically, the input device is the operation panel 4 illustrated in FIG. 1 or 2, and the operation panel 4 includes the display unit 40, and the operation history acquisition unit 41 and the state change history acquisition unit 42 serving as the information processing units. As illustrated in FIGS. 3A and 3B, the display unit 40 displays information regarding the equipment 22 and functions as the input unit that receives the input operation from the operator 1.

The operation panel 4 serving as the input device can include a communication unit capable of communicating with the equipment 22, and the information processing unit may acquire the second information via the communication unit. That is, the input device can be the operation panel 4 as described with reference to FIGS. 1, 2, and 19.

For example, in a case where the handling of the error 1000 is performed as illustrated in the flowchart of FIG. 4, the operation history acquisition unit 41 acquires the operation information (operation history) of the input operation on the operation panel 4 by the operator 1 as described with reference to FIG. 5A. In a case where the operator 1 performs the work on the equipment 22 without using the operation panel 4, the state change history acquisition unit 42 acquires the state change information (state change history) from the equipment 22 as described with reference to FIG. 5B.

Based on the acquired operation history information and state change history, the operation panel 4 arranges the operation information and the state change information in time series as in the data list of FIG. 6, performs the information processing described in the flowchart of FIG. 7, and creates the work handling screen as illustrated in FIG. 8B.

In a case where the work handling screen is created only with the history of the input operation as illustrated in FIG. 5A, a screen in which only the operation buttons are arranged as illustrated in FIG. 8A is created. Only the input operations performed by the operator on the operation panel 4 in steps 802, 803, 807, and 808 in FIG. 4 are displayed. Since information regarding the work on the equipment 22 performed without performing the input operation on the operation panel 4, that is, steps 804, 805, and 806 in FIG. 4, is not displayed, it may take time for the operator 1 to determine what work should be performed at what timing. In particular, in the case of an unskilled operator, it takes time to handle the error.

On the other hand, in a case where the work handling screen as illustrated in FIG. 8B, which is a desirable embodiment, is created, in addition to the input operation on the operation panel 4, information regarding step 804, step 805, and step 806 in FIG. 4, which correspond to the work on the equipment 22, is displayed as the label 444, the label 445, and the label 446 in time series in association with each other. For example, “open safety door” in step 804 is displayed in a display format in which the operator can determine a work content, such as “safety door closed → opened” on the label 444.

As described above, if the image illustrated in FIG. 8B, which is a desirable embodiment, is displayed, the operator 1 only needs to perform the work on the equipment 22 according to the work content displayed on the operation panel 4, so that the operator 1 does not make an error in a work procedure and a time for determining what work should be performed is shortened.

As described above, according to the present embodiment, it is possible to provide the operation panel that enables quick completion of the work performed by the operator at the production site. That is, it is possible to appropriately support the operator such that the operator can perform an operation of controlling the operation of the equipment or the like using the input device and various types of work performed on the equipment in a short time without errors. In addition, various types of work on the equipment include work performed without using the input device. Even in this case, the operator can grasp the work to be performed on the equipment, so that it is possible to appropriately support the operator.

### SECOND EMBODIMENT

In a second embodiment, an operation panel that can support an operator to quickly complete work at a production site by using a plurality of pieces of history information recorded (acquired) in the past will be described.

An operation panel exemplified as the second embodiment is an input device in which an information processing unit holds a plurality of pieces of data in which information regarding an input operation on an input unit is associated with information regarding a history of a state change of equipment caused by the input operation or work, and sorts the plurality of pieces of data according to a first condition to generate an image. The first condition may be a length of a time required to change the equipment to a predetermined state. Alternatively, the first condition may be the number of times each piece of the data is displayed on a display unit.

Specifically, the input device is an operation panel having a function of holding a plurality of pieces of handling history data in which information regarding the input operation is associated with information regarding the state change of the equipment like the handling history dictionary described with reference to FIG. 11, and sorting the pieces of held data under a specific condition like the button 477 of FIG. 11.

As illustrated in FIG. 11, in a case where a plurality of handling histories are recorded in the past for an error of the same type, there are a plurality of pieces of handling history data. The handling history recorded in the past may have a difference in content depending on a skill level, a work time, a work procedure, and the like of the operator who has handled the error. For example, in a case where it takes time for determination or action during the work, a large value is recorded as an elapsed time for handling. In a case where the operator performs unnecessary work, the number of works increases in the handling history. On the other hand, among the plurality of handling histories, there may be a handling history in which a skilled operator completes the work in a short time by an appropriate procedure.

Therefore, in a case where the handling histories are sorted in ascending order of the elapsed time for handling in the last row of the data table 485, a handling history with the shortest elapsed time for handling can be displayed at the top of the list 474. In this case, since the operator 1 who is currently trying to perform the work can easily find the handling history with the shortest elapsed time for handling, the operator 1 can easily obtain a guideline for completing the work in a short time.

As another example, in a case where the handling histories are sorted in descending order of the reproduction count of the label 484, a handling history having the largest reproduction count can be displayed at the top of the list 474. In this case, the operator 1 who is currently trying to perform the work can quickly find the handling history with the largest reproduction count. The handling history with the largest reproduction count is a handling history that has been most frequently referred to and used by the past operators aiming to complete the work in the shortest time. Therefore, the operator 1 can obtain a guideline for completing the work in a shorter time by using the handling history with the largest reproduction count.

As described above, according to the present embodiment, since a display image can be generated by sorting, based on usefulness, a plurality of pieces of history information recorded (acquired) in the past, it is possible to provide the operation panel that enables quick completion of the work performed by the operator at the production site.

### THIRD EMBODIMENT

In a third embodiment, an operation panel configured to enable an operator to arbitrarily edit an image in which information regarding an input operation on the operation panel is associated with information regarding a history of a state change of equipment caused by the input operation or work on the equipment will be described.

The operation panel exemplified as the third embodiment is an input device in which an information processing unit displays data in which information regarding an input operation on an input unit is associated with information regarding a history of a state change of equipment caused by the input operation or work on a display unit so as to be editable by a user.

Specifically, the operation panel according to the present embodiment is an operation panel having a function of editing a value of a handling history as in the data table 485 of FIG. 11. For example, the operator performs unnecessary operation or work while recording the handling history in some cases. In this case, since unnecessary information is recorded in the data table 485, another operator who uses the handling history may take unnecessary time for work. If the value in the data table 485 can be edited, it is possible to create a handling history that serves as a guideline for performing the work in a more appropriate procedure.

In addition, the work may be added to the handling history as one of functions of editing the handling history. In a case where there is information regarding an appropriate handling method for a trouble, the handling method can be added by editing to create the handling history without actually executing the handling method and recording the handling history.

As described above, according to the present embodiment, it is possible to edit the image in which the information regarding the input operation is associated with the information regarding the history of the state change of the equipment caused by the input operation or work, so that the operator can easily grasp an appropriate work procedure. That is, by using the operation panel according to the present embodiment, the work performed by the operator at the production site can be quickly completed.

### FOURTH EMBODIMENT

In a fourth embodiment, an operation panel capable of displaying an image that enables an operator to easily recognize a content of work to be performed on equipment will be described.

The operation panel exemplified as a fourth embodiment is an input device in which an information processing unit converts at least a part of data in which information regarding an input operation on an input unit is associated with information regarding a history of a state change of the equipment caused by the input operation or work according to a predetermined rule to generate an image. That is, the information processing unit may convert predetermined data regarding the history of the state change of the equipment into predetermined display information recognizable by a user to generate the image.

Specifically, as described with reference to FIG. 12, the operation panel according to the present embodiment is the operation panel 4 having a function of replacing a value of state information with another value under a specific condition. For example, as illustrated in FIG. 5B, in a case where state change information is expressed by a numerical value of 0 or 1, if the recorded numerical value is used as it is, a “value before change” and a “value after change” in the data table 485 on the handling screen of FIG. 11 are 0 or 1. In a case where the “value before change” and the “value after change” of the “safety door” are displayed as numerical values, there is a possibility that the operator 1 cannot immediately determine what kind of work should be performed or makes an erroneous determination.

On the other hand, as in the present embodiment, if a text of information regarding the state change is “safety door”, and the value before change is converted into “closed” and the value after change is converted into “opened” and displayed, the operator 1 can accurately determine what kind of work should be performed in a short time. That is, by using the operation panel according to the present embodiment, the work performed by the operator at the production site can be quickly and appropriately completed.

### FIFTH EMBODIMENT

In a fifth embodiment, an operation panel in which unnecessary data is automatically deleted and image display including redundant information is not performed will be described.

The operation panel exemplified as the fifth embodiment is an input device in which an information processing unit deletes at least a part of information regarding control performed on equipment using an input unit and/or at least a part of information regarding a state change of the equipment caused by work performed on the equipment without using the input unit among pieces of acquired information according to a second condition. The second condition may be the lapse of a predetermined time since the end of the image display on a display unit. Furthermore, in another case, the second condition may be a case where an input operation on the input unit is not performed even after a predetermined time has elapsed from the start of acquisition of the information regarding control performed on the equipment using the input unit. In another case, the second condition may be a case where the number of pieces of information regarding the state change of the equipment caused by the work performed on the equipment without the input unit exceeds a predetermined number. In another case, the second condition may be a case where a deletion instruction from the user is received.

Specifically, the operation panel according to the present embodiment is an operation panel having a function of deleting a handling history, which is data in which information regarding the input operation is associated with information regarding the state change of the equipment 22, according to a specific condition as illustrated in FIG. 13.

For example, like the check box 535 illustrated in FIG. 13, a configuration in which a record is automatically deleted when a predetermined time elapses after the end of reproduction of the handling history is possible. In this case, it is possible to automatically delete the handling history that has not been used by the operator for a long period of time.

Furthermore, the handling history may be deleted when a reproduction count is small. If an unnecessary handling history that has not been used can be deleted, the operator can easily find an appropriate handling history.

In addition, like the check box 531, when a certain period of time has elapsed during recording of the handling history, the recording may be automatically stopped, and the handling history may be deleted. It is possible to prevent an unnecessary handling history from being recorded in a case where the operator forgets to issue an instruction to stop the recording during the recording of the handling history.

In addition, like the check box 533, the recording may be automatically stopped and the handling history may be deleted when the number of works reaches a certain number during the recording of the handling history. In a case where the operator performs a lot of work that is not originally necessary during the recording of the handling history and the handling history is obviously inappropriate (high redundancy), the recording of the unnecessary handling history can be automatically stopped, and the unnecessary handling history can be deleted.

By using the operation panel according to the present embodiment, unnecessary data is automatically deleted, and the image display including the redundant information is not performed, so that work performed by the operator at a production site can be quickly completed.

### SIXTH EMBODIMENT

In a sixth embodiment, an operation panel capable of displaying a handling history in association with occurrence of a specific event such as occurrence of an error in equipment will be described.

The operation panel exemplified as the sixth embodiment is an input device in which an information processing unit generates an image based on first information and second information associated with the specific event related to the equipment and displays the image on a display unit. The specific event may be processing performed in a case where an operation error occurs in the equipment. Alternatively, the specific event may be any one of inspection, maintenance, and repair of the equipment.

Specifically, the operation panel of the present embodiment is an operation panel having a function of displaying data in which information regarding an input operation and information regarding a state change of the equipment are associated with a specific condition (occurrence of an event).

As an example, like the check box 537 illustrated in FIG. 13, it is possible to perform setting to automatically display the handling history related to an error when the error occurs. With such a setting, it is possible to save time and effort for the operator to search for the handling history when an error occurs, so that it is possible to quickly start handling of the error. As a condition of the handling history related to the error, matching between an error number and a handling history ID may be set.

In addition, like the check box 539 illustrated in FIG. 13, an error handling reproduction screen such as the handling reproduction screen 560 in FIG. 17 may be set to be automatically displayed when an error occurs. If the handling reproduction screen is automatically displayed when an error occurs, the operator does not need to select the handling history from the handling history screen of FIG. 11 and press the button 488 for reproducing the screen, and can quickly start error processing.

By using the operation panel according to the present embodiment, it is possible to display the handling history in association with the occurrence of the specific event, and thus, it is possible for the operator to immediately start handling of the event at a production site.

### SEVENTH EMBODIMENT

In a seventh embodiment, an operation panel that displays, to an operator, an image in which a treatment to be performed next is easily recognizable according to an input operation on the operation panel or the progress of work on equipment will be described.

The operation panel exemplified as the seventh embodiment is an input device in which an information processing unit changes the image according to a third condition and displays the image on a display unit. The third condition is that the acquired first information and/or the acquired second information is updated, for example. The information processing unit is configured to change the image such that a user can recognize an updated portion and display the image on the display unit.

Specifically, as described with reference to FIG. 17, the operation panel of the present embodiment is an operation panel having a function of changing a method of displaying information regarding the input operation or information regarding a state change of the equipment according to a specific condition.

For example, the handling reproduction screen 560 illustrated in FIG. 17 is displayed when a target handling history is selected in FIG. 11 and then the button 488 is pressed (selected). The region 562 illustrated in FIG. 17 is a region in which a work handling screen created based on the handling history is displayed. The operator can perform work in an appropriate procedure by sequentially processing the buttons or labels displayed in the region 562 from the top. At this time, among the buttons or labels displayed in the region 562, the colors of the buttons or labels may be changed such that a color of a button or label for which the work has already been completed is gray, and a color of a button or label for which the work is to be performed next is red. In the example of FIG. 17, a color of the button 563 is changed, and it is indicated that the input operation to be performed next is the pressing (selection) of the button 563. As described above, by changing the method of displaying the information regarding the input operation or the information regarding the state change of the equipment according to the specific condition, the operator 1 can easily grasp how far the operator 1 has completed the treatment (input operation or work) and what kind of treatment (input operation or work) should be performed next. Therefore, the operator 1 can quickly and appropriately determine a treatment to be performed next.

By using the operation panel according to the present embodiment, the image can be changed and displayed on the display unit according to the third condition (for example, the input operation on the operation panel or the progress of the work on the equipment), so that the input operation and work performed by the operator can be promptly and appropriately advanced at a production site.

### EIGHTH EMBODIMENT

In an eighth embodiment, an operation panel that displays a diagram related to a work target and/or information regarding a state of the work target on a display unit will be described. An image displayed on the operation panel exemplified as the eighth embodiment includes a diagram related to equipment (for example, a diagram of an arrangement of components of the equipment) and/or information indicating a state of the equipment.

Specifically, as described with reference to FIGS. 18 and 21, the operation panel according to the present embodiment has a function of displaying the diagram related to the work target and/or the information regarding the state of the work target on the display unit 40.

Displaying the diagram related to the work target can be, for example, displaying the arrangement of the components of the equipment 22 on the screen 580 or the screen 590. In addition, displaying the information regarding the state of the work target can be, for example, displaying on the screen 580 or the screen 590 such that the operator can recognize an opened/closed state of a safety door, the presence or absence of a workpiece, and a position where the workpiece is present in a case where the workpiece is present. Alternatively, for example, on the handling reproduction screen 560, a display color of a safety door label may be changed according to opening and closing of the safety door, or a display color of a workpiece label may be changed according to the presence or absence of the workpiece.

For example, in a case where work related to the safety door is displayed on the handling reproduction screen 560, if a position where the safety door is disposed in the equipment 22 of the production device 2 is displayed on the screen 580 or the screen 590, the operator 1 can quickly and appropriately determine where to perform the work related to the safety door.

In addition, by displaying the “opened” or “closed” state of the safety door on the screen 580 or the screen 590, the operator 1 can quickly and accurately grasp the state of the safety door. Alternatively, if the “opened” or “closed” state of the safety door is displayed using the color of the label on the handling reproduction screen 560, the operator 1 can quickly and accurately grasp the state of the safety door. As a result, the operator can more quickly determine the start or end of the work.

By using the operation panel according to the present embodiment, the diagram related to the work target and/or the information regarding the state of the work target are displayed on the display unit, so that the operator can immediately and appropriately start the treatment to be performed next.

### NINTH EMBODIMENT

In a ninth embodiment, an operation panel that displays a position of an input device (operation panel) with respect to equipment on a display unit will be described.

An information processing unit of the operation panel exemplified as the ninth embodiment acquires information regarding the position of the input device (operation panel) with respect to the equipment, generates an image including the information regarding the position, and displays the image on the display unit. The input device (operation panel) may include a wireless communication unit capable of communicating with the equipment, and the information processing unit may be configured to acquire the information regarding the position of the input device with respect to the equipment via the wireless communication unit. The information processing unit can specify a position of an operator with respect to the equipment based on the acquired position of the input device (operation panel), generate an image indicating the position of the operator, and display the image on the display unit.

Specifically, the operation panel according to the present embodiment includes the wireless communication function described with reference to FIG. 19 and the position information acquisition unit 45 described with reference to FIG. 20. Then, the operation panel specifies the position of the operator based on the position of the operation panel and displays information regarding the position of the operator on the display unit 40 together with a diagram related to a work target as in the screen 590 of FIG. 21.

For example, in a case where a relationship between each component of the equipment that is the work target and the position of the operator 1 is displayed as in the screen 590, the operator 1 can quickly grasp where a target for which work is to be performed next is with respect to the current position of the operator 1.

By using the operation panel according to the present embodiment, information regarding a positional relationship between the operator himself/herself and the work target is displayed on the display unit, so that the operator can immediately and appropriately start a treatment to be performed next.

### TENTH EMBODIMENT

In a tenth embodiment, an operation panel that displays an item to be input to the operation panel and work to be performed on equipment by an operator in relation to the item will be described.

In the operation panel exemplified as the tenth embodiment, an information processing unit is configured to generate an image in which the item to be input is associated with the work that is to be performed on the equipment by a user without using an input unit and is related to the item, and display the image on a display unit.

Specifically, as illustrated in FIG. 24, the operation panel according to the present embodiment is an operation panel configured to display information to be input (for example, releasing of a workpiece) and information regarding a work target related thereto (for example, opening and closing of a safety door, and the presence or absence of the workpiece) on the display unit.

For example, as in the group 4250 illustrated in FIG. 22B, the button 4252 indicating an operation to be instructed to the equipment by an input operation and the label 4251 indicating an operation target may be displayed separately. In this case, there is an advantage that the operator can easily grasp a content of information displayed on the screen by separately indicating the operation and the operation target.

However, in a case where only information regarding a button ID in the column 703 is recorded as in the data list illustrated in FIG. 6 when the button 4252 is operated, a button indicating only an operation name of “release” is displayed on a work handling screen, and it is thus not possible to determine what the operation target is.

On the other hand, when the button 4252 is operated, if information regarding a group ID of the group 4250 including the button 4252 is added and recorded as in the column 707 of FIG. 23, the region 572 illustrated in FIG. 24 can be displayed on the work handling screen. That is, like the group 5730, the label 5731, and the button 5732 illustrated in FIG. 24, the operation target “workpiece” and the operation name “release” can be displayed on the work handling screen.

By using the operation panel according to the present embodiment, the item to be input to the operation panel and the work to be performed on the equipment by the operator in relation to the item are displayed in association with each other, so that the operator can immediately and appropriately start a treatment to be performed next.

### MODIFIED EMBODIMENT

The present disclosure is not limited to the embodiments described above, and many modifications can be made within the technical idea of the present disclosure. For example, all or some of the different embodiments described above may be combined and implemented.

The input device according to the above-described embodiment can be used as an input device for controlling various types of equipment in addition to the production device. For example, a robot may be used as the production device, and a teaching pendant that outputs an operation command to the robot may be implemented as the input device according to the embodiment. A control method for controlling various types of equipment other than the production device by inputting control information from the input device according to the embodiment also corresponds to the embodiment of the present disclosure. Examples of the various types of equipment include a device capable of performing an operation of extension and contraction, bending and stretching, vertical movement, horizontal movement, or turning, or a combined operation thereof, like a robot, and the robot includes various types such as a vertical articulated type, a parallel-link type, and a linear joint type. The robot may be various service robots in addition to an industrial robot.

Examples of the equipment operated by connecting the input device according to the embodiment include various production devices used for manufacturing an article. The operation to be performed by the production device using the input device according to the embodiment is typically an operation related to manufacturing of an article, which is represented by assembly of parts, transfer, machining (including cutting, polishing, drilling, painting, bonding, welding, and the like), and cleaning. The embodiment of the present disclosure also includes the article manufacturing method for manufacturing the article by inputting information related to control of equipment used for manufacturing the article from the input device according to the embodiment and controlling the equipment.

The present disclosure can also be implemented by processing in which a program for implementing one or more functions of the embodiments is supplied to a system or a device via a network or a storage medium, and one or more processors in a computer of the system or the device read and execute the program. The present disclosure can also be implemented by a circuit (for example, an application-specific integrated circuit (ASIC)) that implements one or more functions.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-063331, filed Apr. 7, 2025, which is hereby incorporated by reference herein in its entirety.

What is claimed is:

1. An input device comprising: an information processing unit; a display unit; and an input unit, wherein
the input unit is configured to receive an input operation for controlling equipment, and
the information processing unit is configured to:
acquire first information regarding the input operation on the input unit and second information regarding a state change of the equipment caused by work performed on the equipment; and
display, on the display unit, an image in which information regarding the input operation is associated with information regarding the state change of the equipment caused by the work based on the first information and the second information.

2. The input device according to claim 1, wherein the information processing unit is configured to hold a plurality of data items in which the information regarding the input operation on the input unit is associated with the information regarding the state change of the equipment caused by the input operation or the work, and sort the plurality of data items according to a first condition to generate the image.

3. The input device according to claim 2, wherein the first condition is at least one of a length of a time required to change the equipment to a predetermined state and a number of times each data item of the plurality of data items is displayed on the display unit.

4. The input device according to claim 1, wherein the information processing unit is configured to display a data item in which the information regarding the input operation on the input unit is associated with the information regarding the state change of the equipment caused by the input operation or the work on the display unit so as to be editable by a user.

5. The input device according to claim 1, wherein the information processing unit is configured to convert at least a part of a data item in which the information regarding the input operation on the input unit is associated with the information regarding the state change of the equipment caused by the input operation or the work according to a predetermined rule to generate the image.

6. The input device according to claim 1, wherein the information processing unit is configured to convert predetermined data regarding the state change of the equipment into predetermined display information recognizable by a user to generate the image.

7. The input device according to claim 1, wherein the information processing unit is configured to delete at least a part of information regarding control performed on the equipment using the input unit and/or at least a part of information regarding a state change of the equipment caused by work performed on the equipment without using the input unit among pieces of acquired information in a case where a second condition is satisfied.

8. The input device according to claim 7, wherein the second condition is at least one of
a condition that a predetermined time has elapsed since the display of the image on the display unit ends,
a condition that the input operation on the input unit is not performed even in a case where a predetermined time has elapsed since acquisition of the information regarding the control performed on the equipment using the input unit starts,
a condition that a number of pieces of the information regarding the state change of the equipment caused by the work performed on the equipment without using the input unit exceeds a predetermined number, and
a condition that a deletion instruction from a user is received.

9. The input device according to claim 1, wherein the information processing unit is configured to generate the image based on the first information and the second information associated with a specific event related to the equipment and displays the image on the display unit.

10. The input device according to claim 1, wherein the information processing unit is configured to change and display the image on the display unit in a case where the first information and/or the second information is updated.

11. The input device according to claim 1, wherein the image includes a diagram related to the equipment and/or information indicating a state of the equipment.

12. The input device according to claim 1, wherein the information processing unit is configured to acquire information regarding a position of the input device with respect to the equipment, generate the image including the information regarding the position, and display the image on the display unit.

13. The input device according to claim 12, wherein the information processing unit is configured to specify a position of an operator based on the information regarding the position of the input device with respect to the equipment, generate the image including the position of the operator, and display the image on the display unit.

14. The input device according to claim 1, wherein the information processing unit is configured to generate the image in which an item for which the input operation is to be performed is associated with work that is to be performed on the equipment by a user without using the input unit and is related to the item, and display the image on the display unit.

15. The input device according to claim 1, wherein the work includes work performed by the input operation and work performed regardless of the input operation.

16. The input device according to claim 1, further comprising a communication unit configured to communicate with the equipment,
wherein the information processing unit is configured to acquire the second information via the communication unit.

17. A control method for controlling an input device which includes an information processing unit, a display unit, and an input unit and in which the input unit receives an input operation for controlling equipment,
the control method comprising:
acquiring, by the information processing unit, first information regarding the input operation on the input unit and second information regarding a state change of the equipment caused by work performed on the equipment; and
displaying, by the information processing unit, an image in which information regarding the input operation is associated with information regarding the state change of the equipment caused by the work based on the first information and the second information on the display unit.

18. A non-transitory computer-readable recording medium recording a program for causing a computer to execute the control method according to claim 17.

19. An article manufacturing method comprising:
manufacturing an article by controlling the equipment using the input device according to claim 1,
wherein the equipment is equipment configured to perform at least a part of an article manufacturing process.
